(19) United States
(12) Patent Application Publication
(10) Pub. No.: US 2016/0101922 A1
(43) Pub. Date: Apr. 14, 2016

(54) SUSPENSION PACK BOX DESIGNS, BLANKS AND METHODS

(71) Applicant: THATBOX DESIGN, LLC, Fort Mill, SC (US)

(72) Inventor: Donn J. Costanzo, JR., Fort Mill, SC (US)

(21) Appl. No.: 14/881,132

(22) Filed: Oct. 12, 2015

Related U.S. Application Data
(60) Provisional application No. 62/062,824, filed on Oct. 10, 2014.

(51) Int. Cl. B65D 81/07; B31B 3/00

(52) U.S. Cl. CPC B65D 81/07; B31B 3/00

(57) ABSTRACT

Box designs, blanks for forming boxes by folding, collapsible and non-collapsible boxes formed thereby, and manufacturing methods therefor are disclosed. Preferably the boxes are formed from cardboard or other corrugated material and include suspension packs for securely shipping items such as, for example and not by way of limitation, wine bottles, candles, and cell phones.

### CROSS-REFERENCE TO RELATED APPLICATION

The present application is a U.S. nonprovisional patent application of, and claims the benefit of priority under 35 U.S.C. §119(e) to, U.S. provisional patent application 62/062,824, filed Oct. 10, 2014, incorporated by reference herein. All of the material in this patent documents is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to box designs, blanks for forming boxes by folding, collapsible and non-collapsible boxes formed thereby, and manufacturing methods therefor. Preferably boxes of the invention are formed from cardboard or other corrugated material and comprise suspension packs for securely shipping items such as, for example and not by way of limitation, wine bottles, candles, and cell phones.

Machines and methods for making collapsible boxes from blanks are well known. Exemplary such machines and methods are disclosed, for example, in U.S. patent application publication 2012/0238423, which is hereby incorporated by reference herein. Preferred embodiments of the invention comprising collapsible shipping packs formed from folded and glued blanks preferably are manufactured using such machines and methods.

### SUMMARY OF THE INVENTION

The present invention includes many aspects and features. Moreover, while many aspects and features relate to, and are described in, the context of shipping packs and, more particular, suspension packs for shipping items such as wine bottles, candles, and cell phones, the present invention is not so limited and applies to other types and uses of boxes, as will become apparent from the following summaries and detailed descriptions of aspects, features, and one or more embodiments of the present invention.

Accordingly, a first aspect of the invention comprises a box comprising a shipping pack as shown and described herein.

Another aspect of the invention comprises an assembled box as shown and described herein.

Another aspect of the invention comprises an assembled, collapsible box as shown and described.

Another aspect of the invention comprises a box in the form of a blank as shown and described.

Another aspect of the invention comprises a method of making any of the foregoing boxes.

Another aspect of the invention comprises a method of assembling any of the foregoing boxes. In features of this aspect, machines and methods as disclosed in U.S. patent application publication 2012/0238423, incorporated by reference herein, are adapted and used to assemble one or more of the foregoing boxes disclosed herein in order to form collapsible, assembled shipping packs. Each such shipping pack generally is collapsible even though in an assembled state preferably by folding along an axis bisecting a bottom panel and opposite end panels thereof.

Another aspect of the invention comprises a method of collapsing and storing any of the foregoing boxes.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6 of section (f), no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

One or more preferred embodiments of the present invention now will be described in detail with reference to the accompanying drawings.

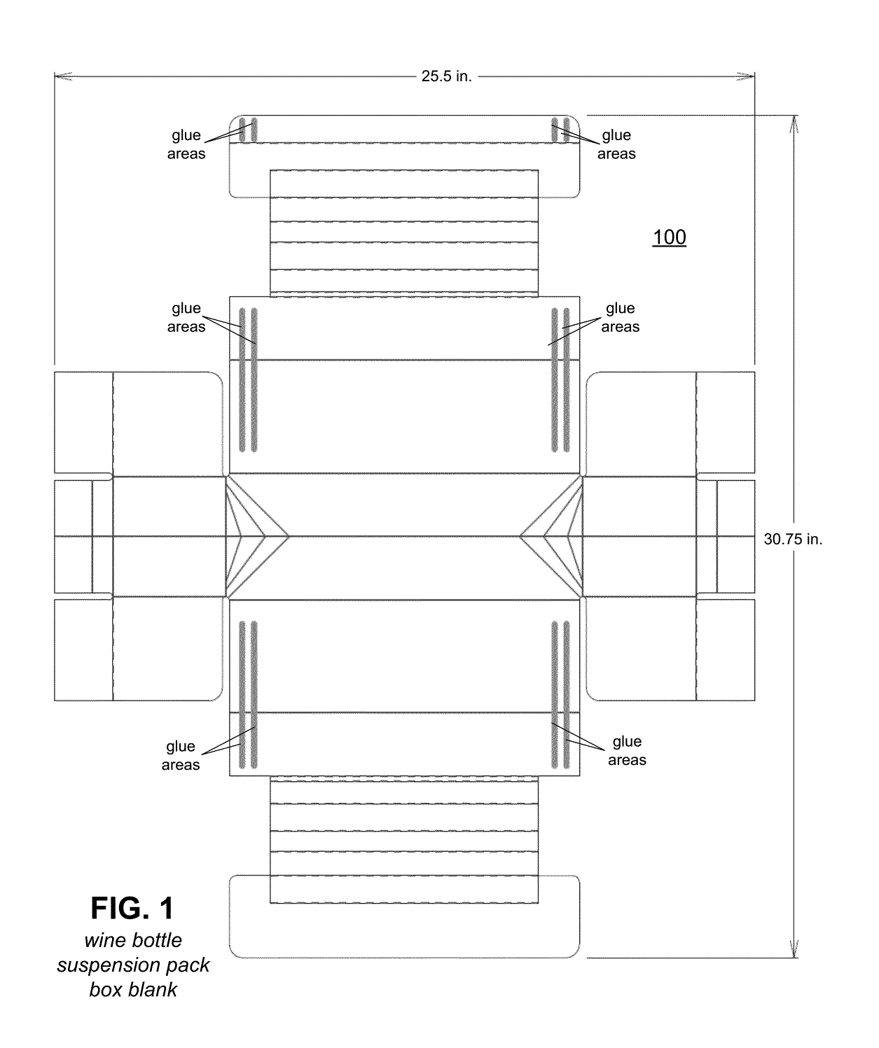

FIG. 1 is a schematic illustration of a preferred box blank in accordance with one or more aspects and features of the present invention; the blank represented in FIG. 1 is designed and dimensioned to accommodate the shipping of a wine bottle. FIG. 1 additionally shows the score or fold lines as well as the areas at which glue is applied when assembling the box by folding using the methods and machines generally disclosed in U.S. patent application publication 2012/0238423, incorporated by reference herein.

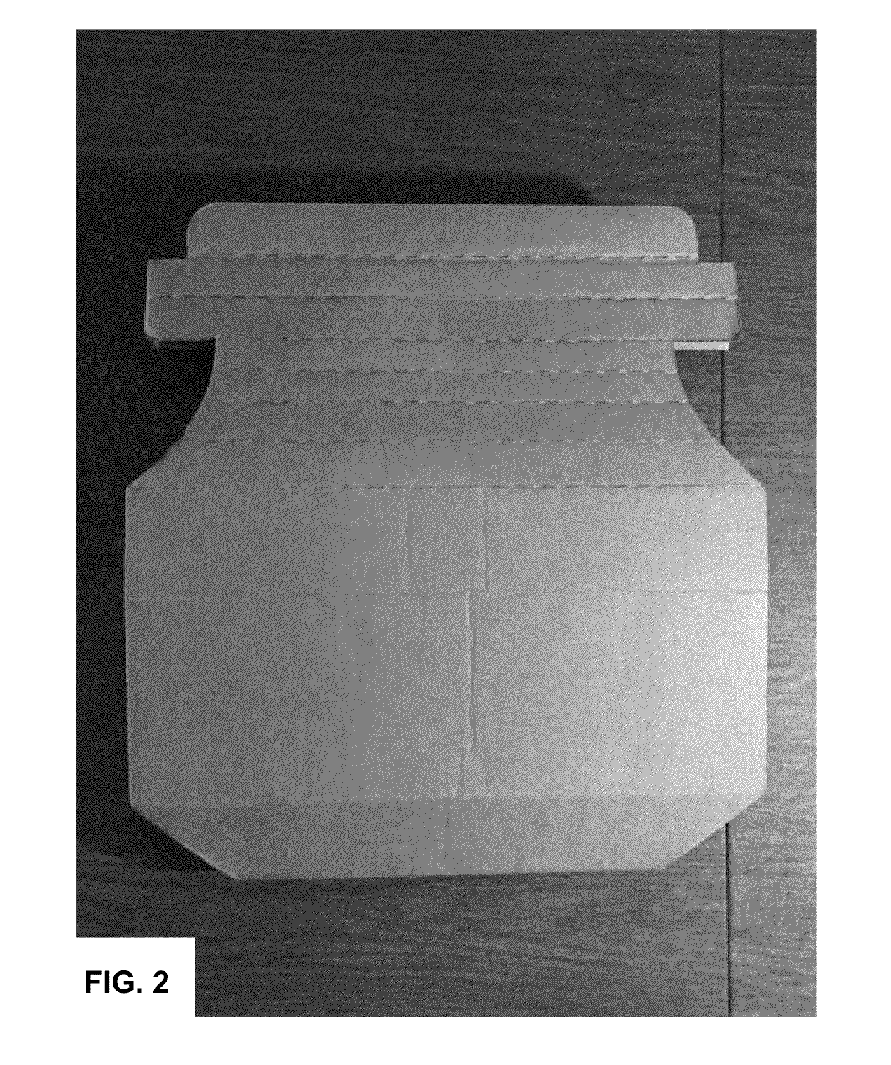

FIG. 2 shows a first side of a prototype of a box that has been assembled by folding and gluing the box blank of FIG. 1, wherein the assembled box is in a collapsed, folded configuration.

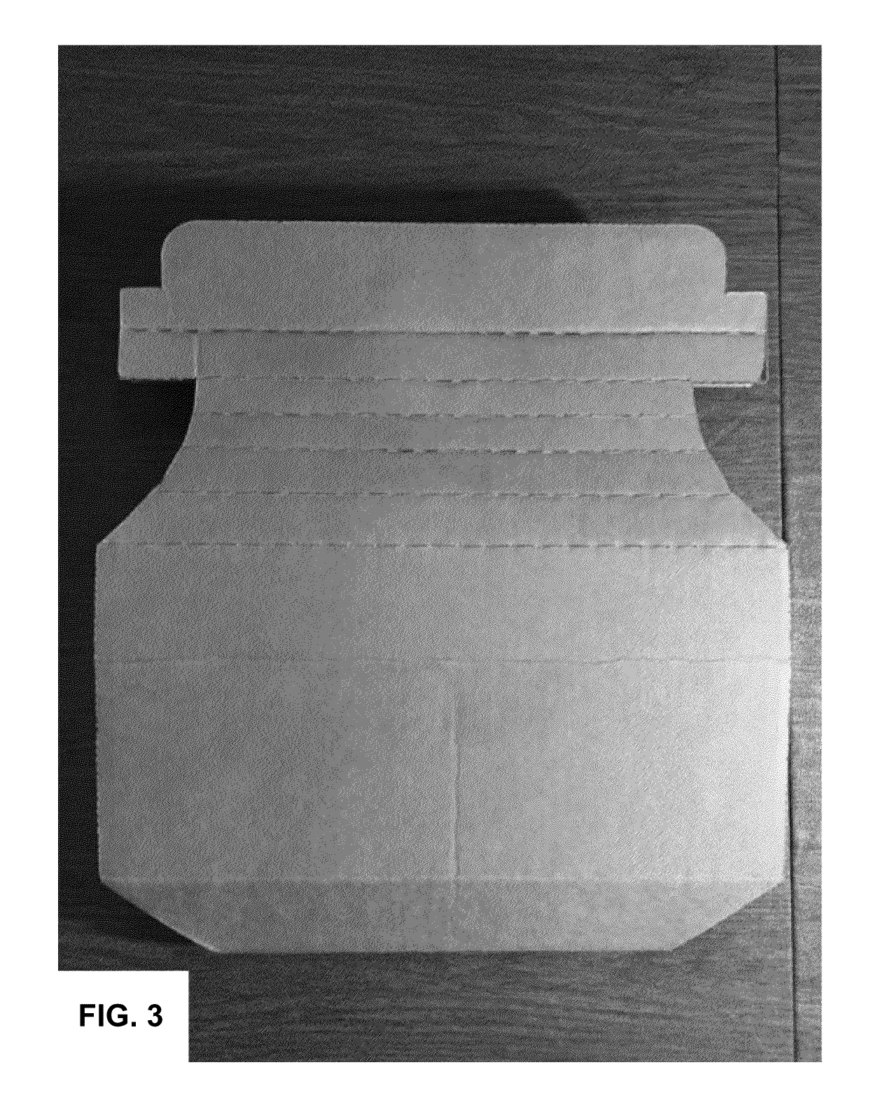

FIG. 3 shows the other side of the box of FIG. 2, wherein the assembled box is in a collapsed, folded configuration.

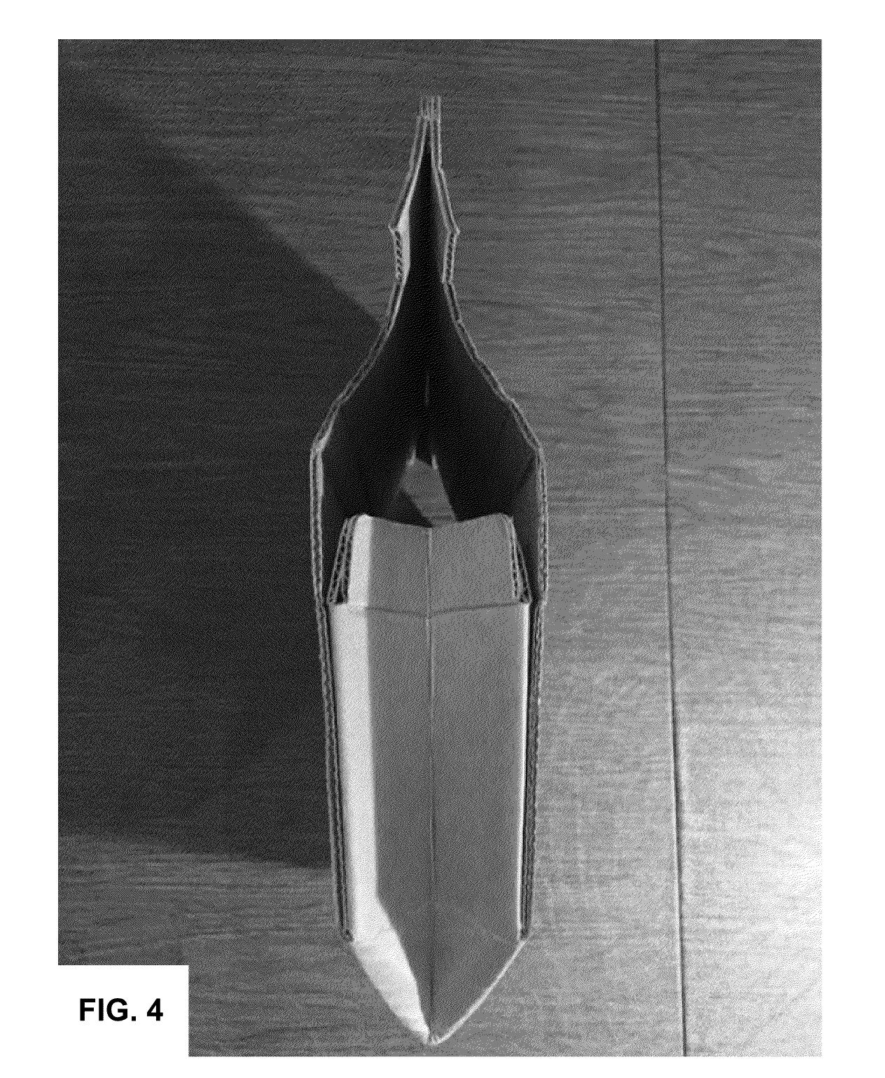

FIG. 4 shows an end of the box of FIG. 2, wherein the assembled box is in a collapsed, folded configuration.

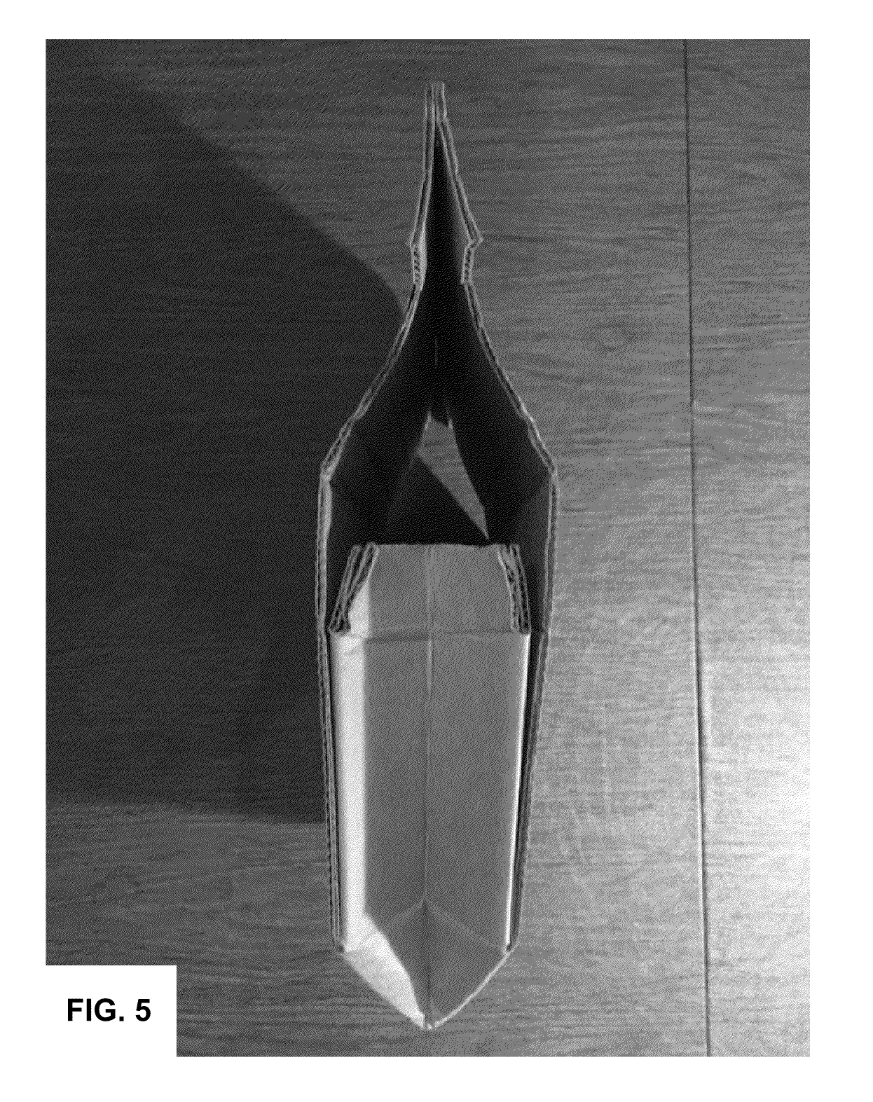

FIG. 5 shows another end of the box of FIG. 2, wherein the assembled box is in a collapsed, folded configuration.

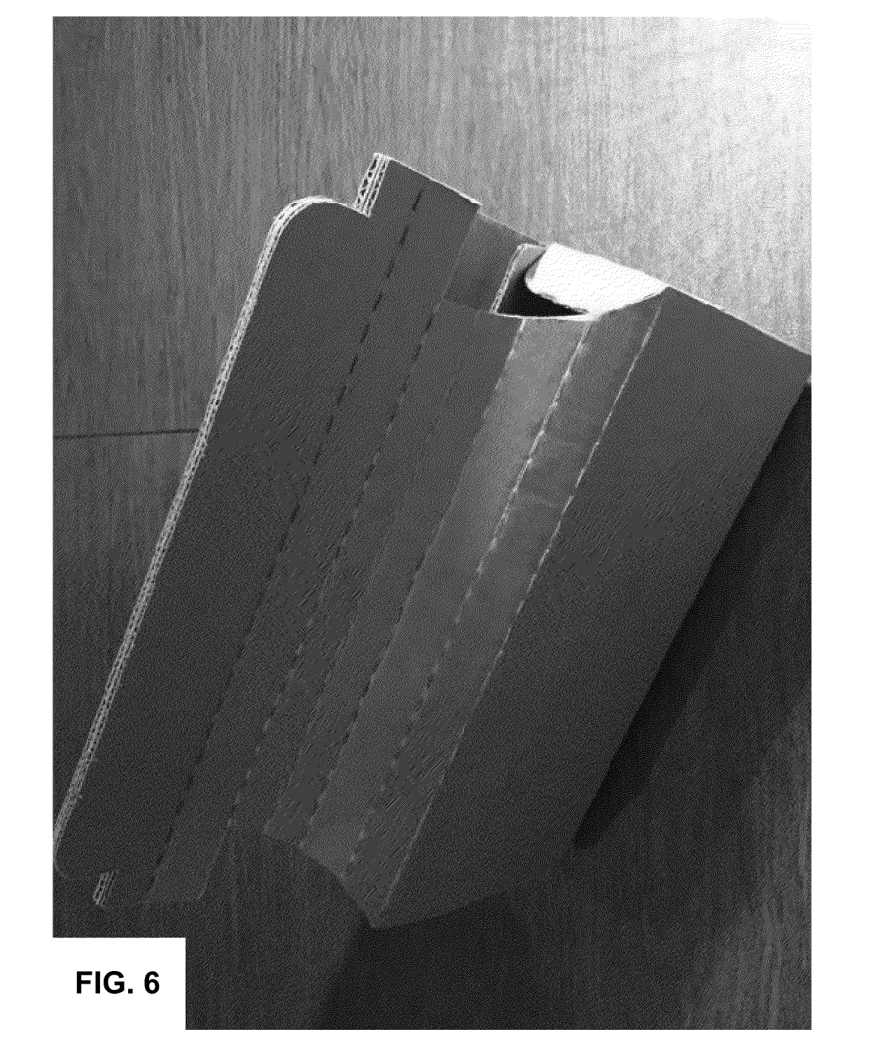

FIG. 6 shows the box of FIGS. 2-5 after expanding the body of the box, with a top portion of the box in an extended position.

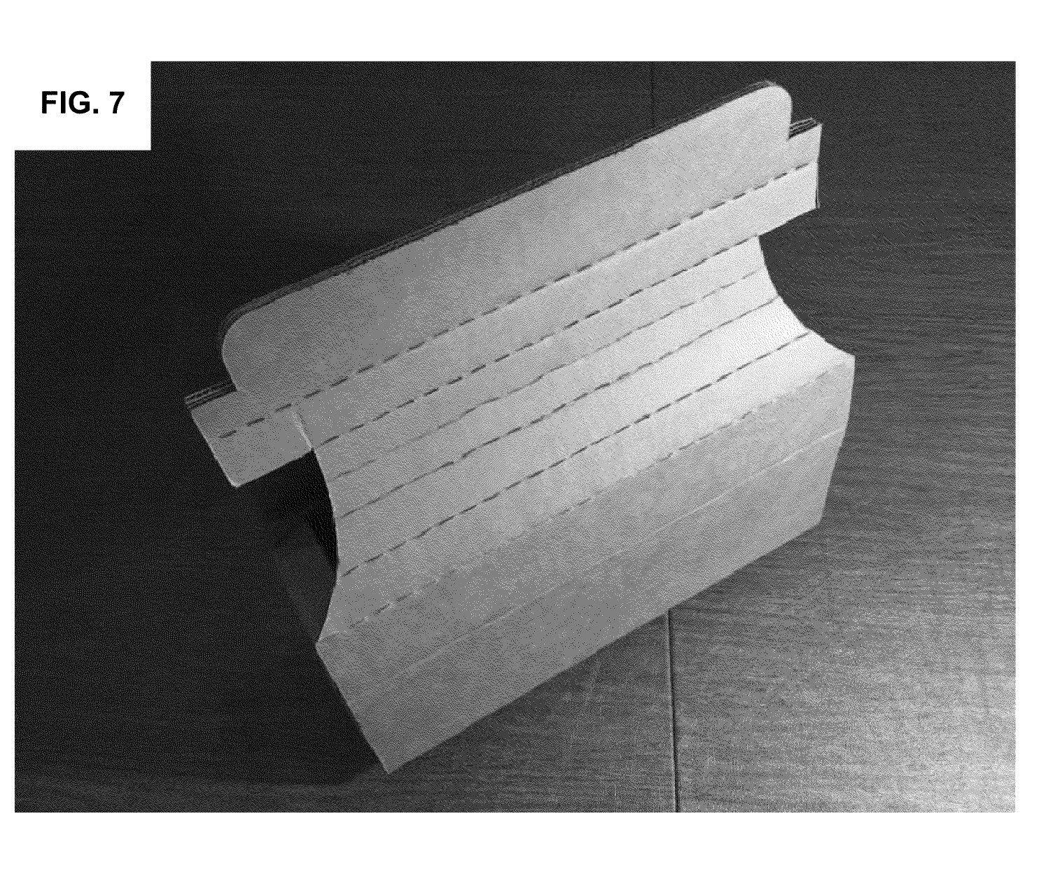

FIG. 7 is another view similar to that of FIG. 6.

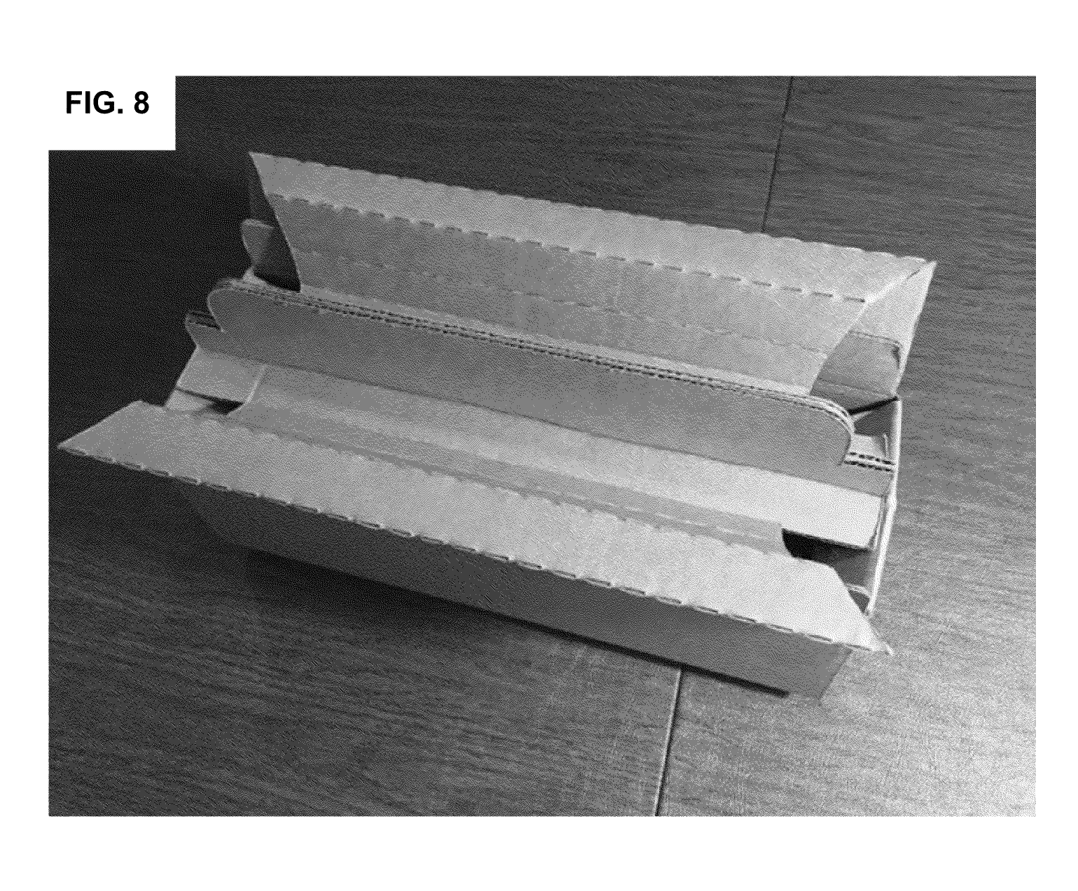

FIG. 8 shows the box of FIGS. 6-7 with the top portion of the box in an intermediate position during folding of the top portion into the interior of the body of the box.

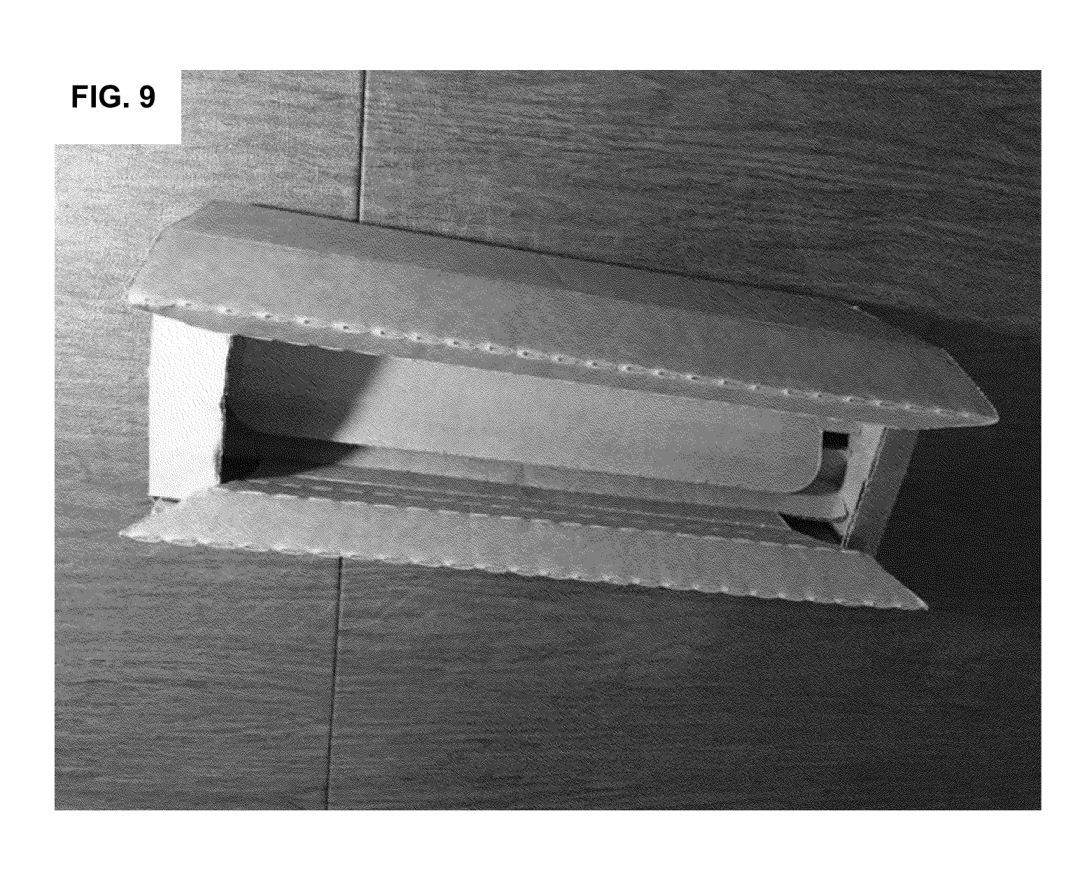

FIG. 9 shows the box of FIG. 8 with the top portion of the box having been folded below the top of the lids into the interior of the body of the box.

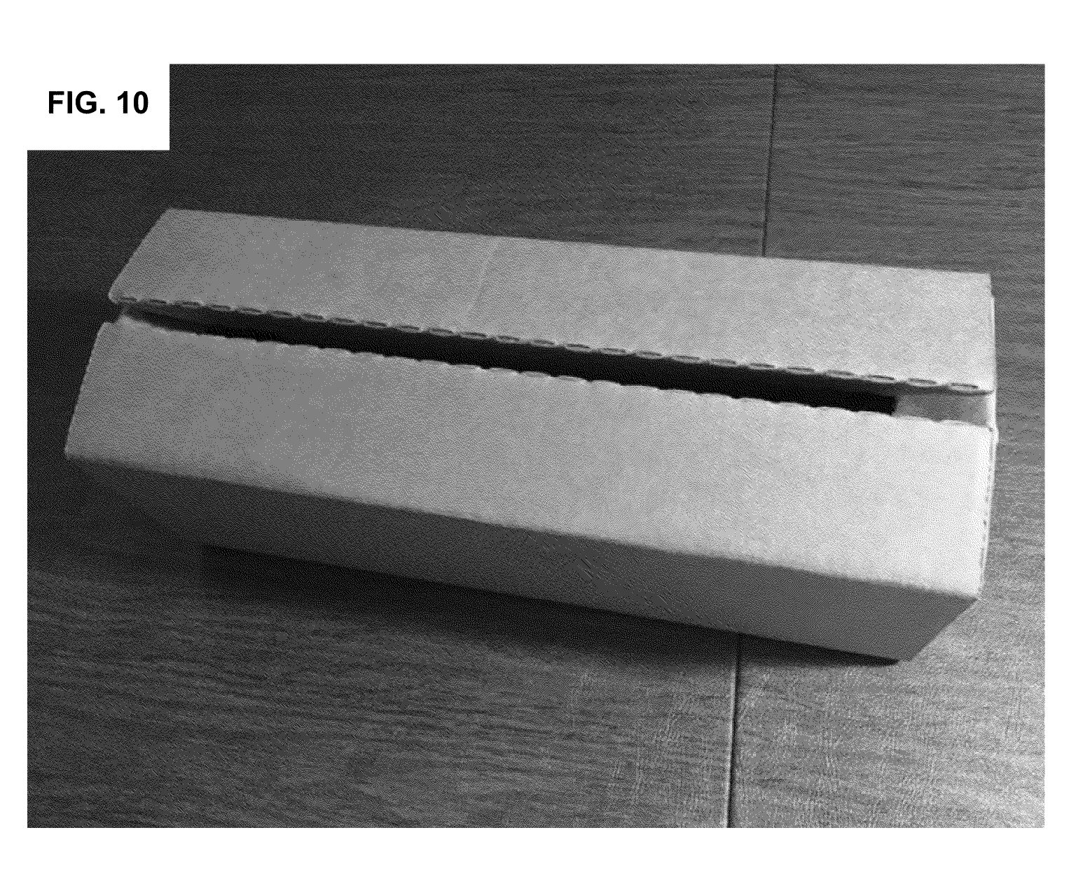

FIG. 10 shows the box of FIG. 9 with the lids in a closed position in a configuration for taping of the box for shipping.

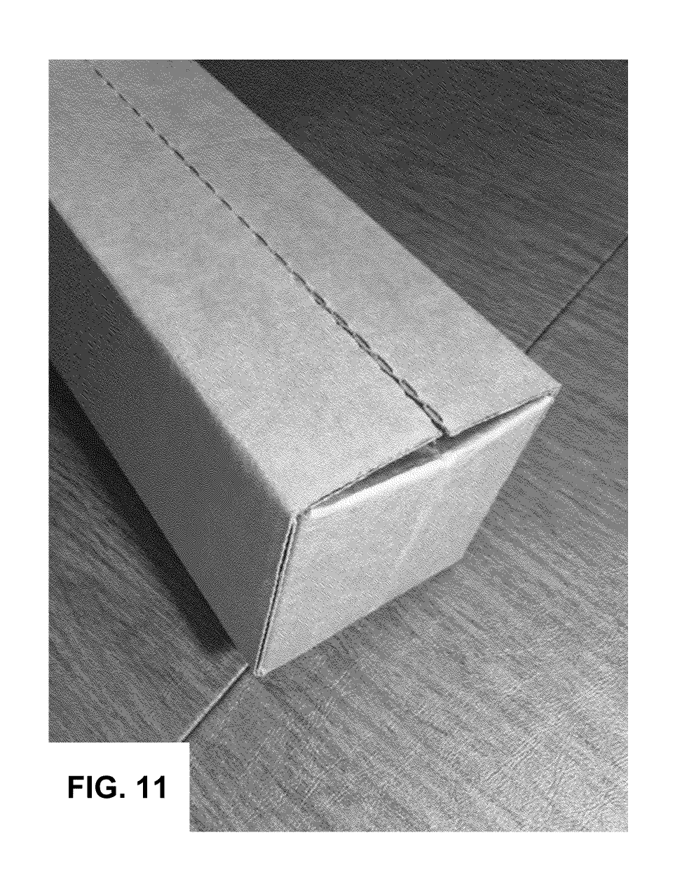

FIG. 11 is another view similar to the of FIG. 10, showing an end of the box.

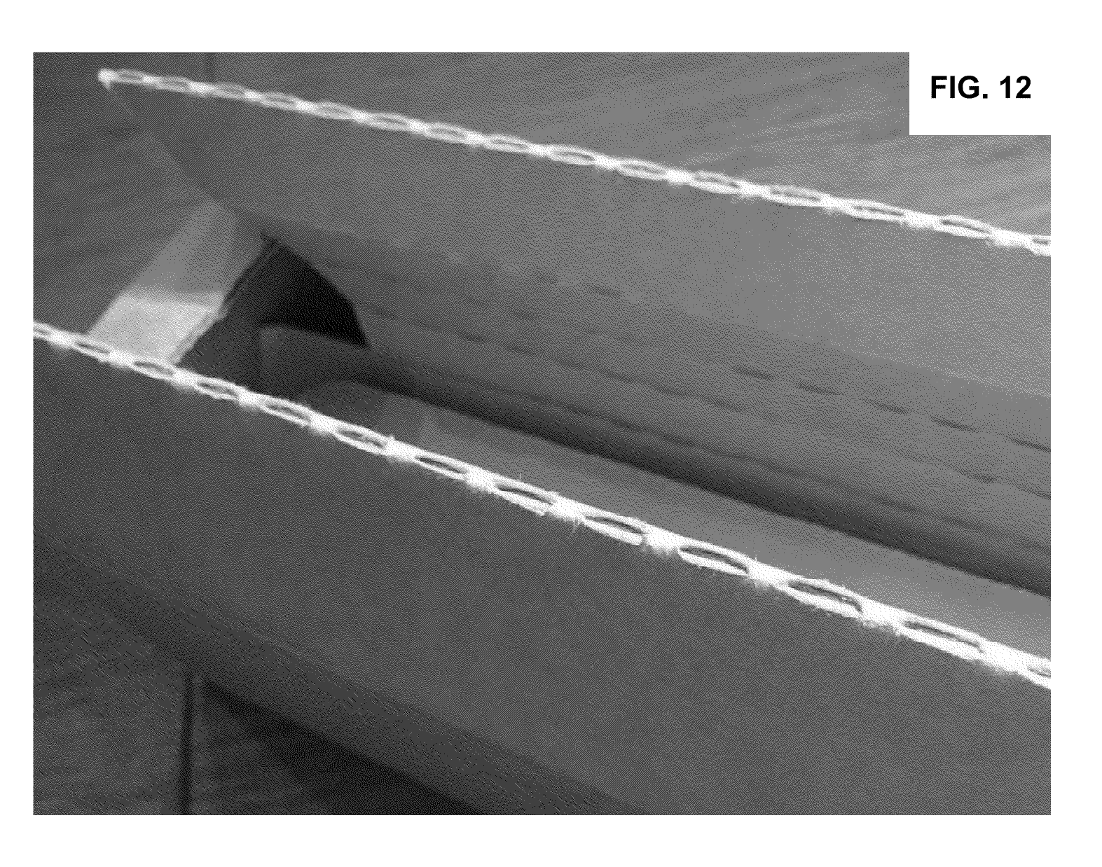

FIG. 12 is a view of the interior of the box illustrating a curved configuration assumed by the top portion when folded into the interior of the body of the box; the curved configuration is intended to receive and generally cradle the body of a bottle of wine and, more particularly, suspend the bottle within the interior of the body of the box in a secured state without additional packing material such as foam pieces, air cushions, bubble wrap, or the like.

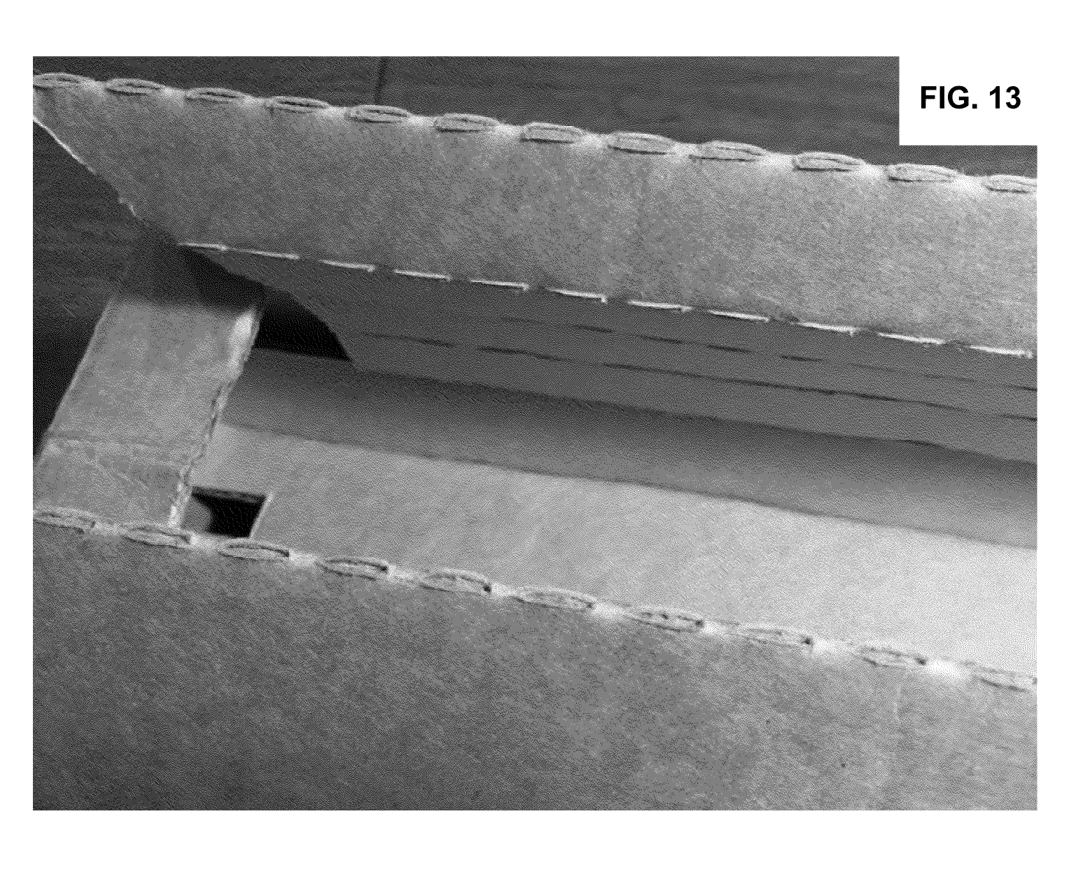

FIG. 13 is a view similar to that of FIG. 12.

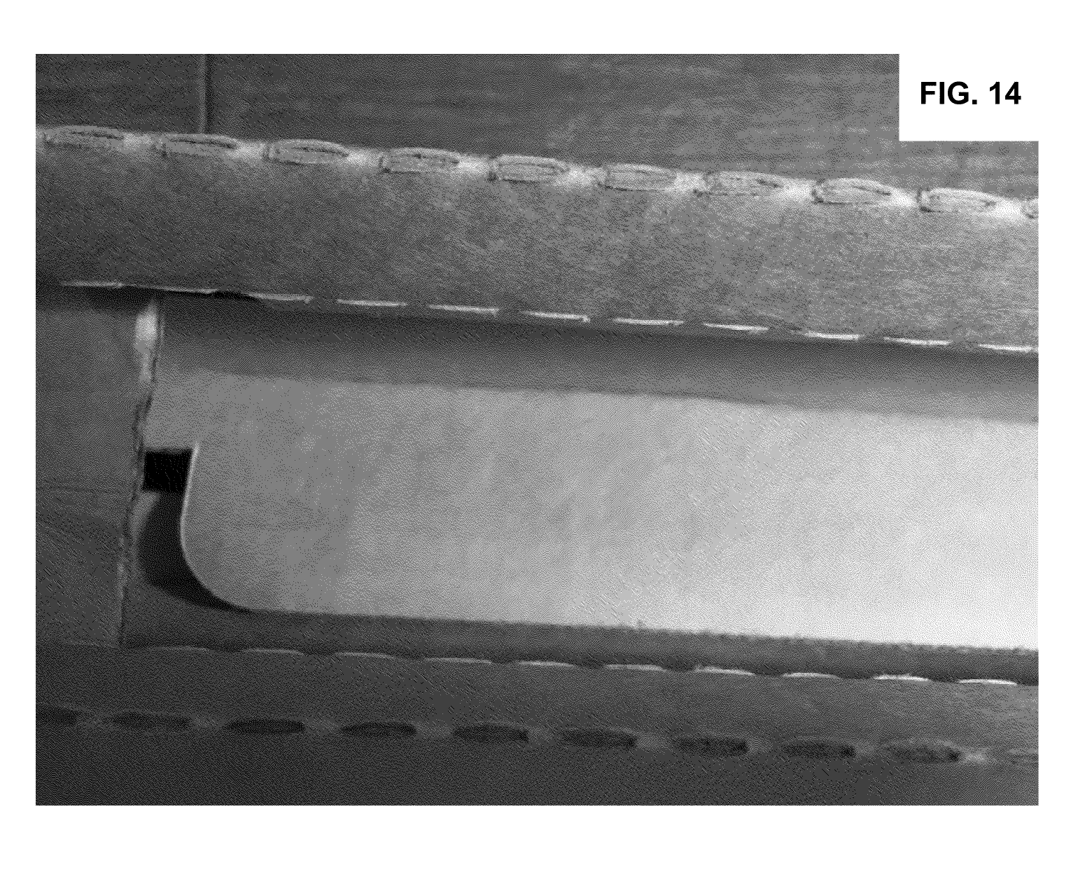

FIG. 14 is a view similar to that of FIG. 12.

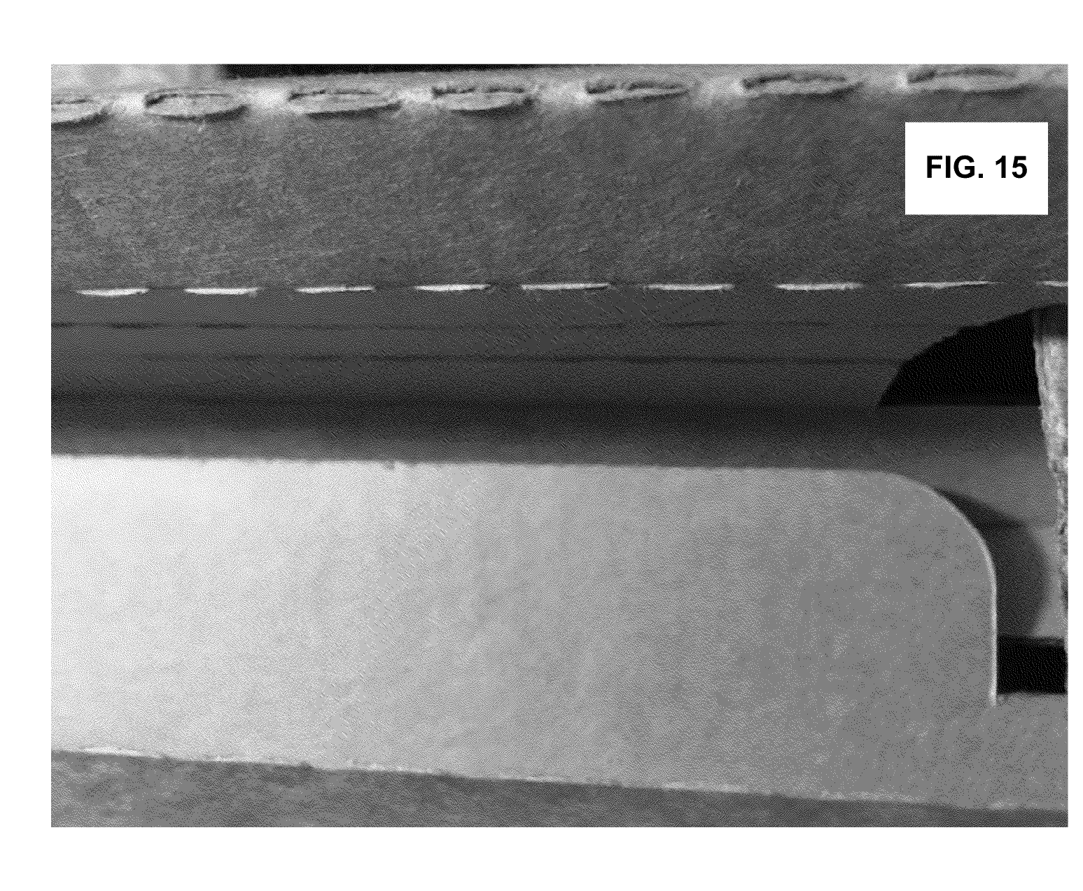

FIG. 15 is a view similar to that of FIG. 12.

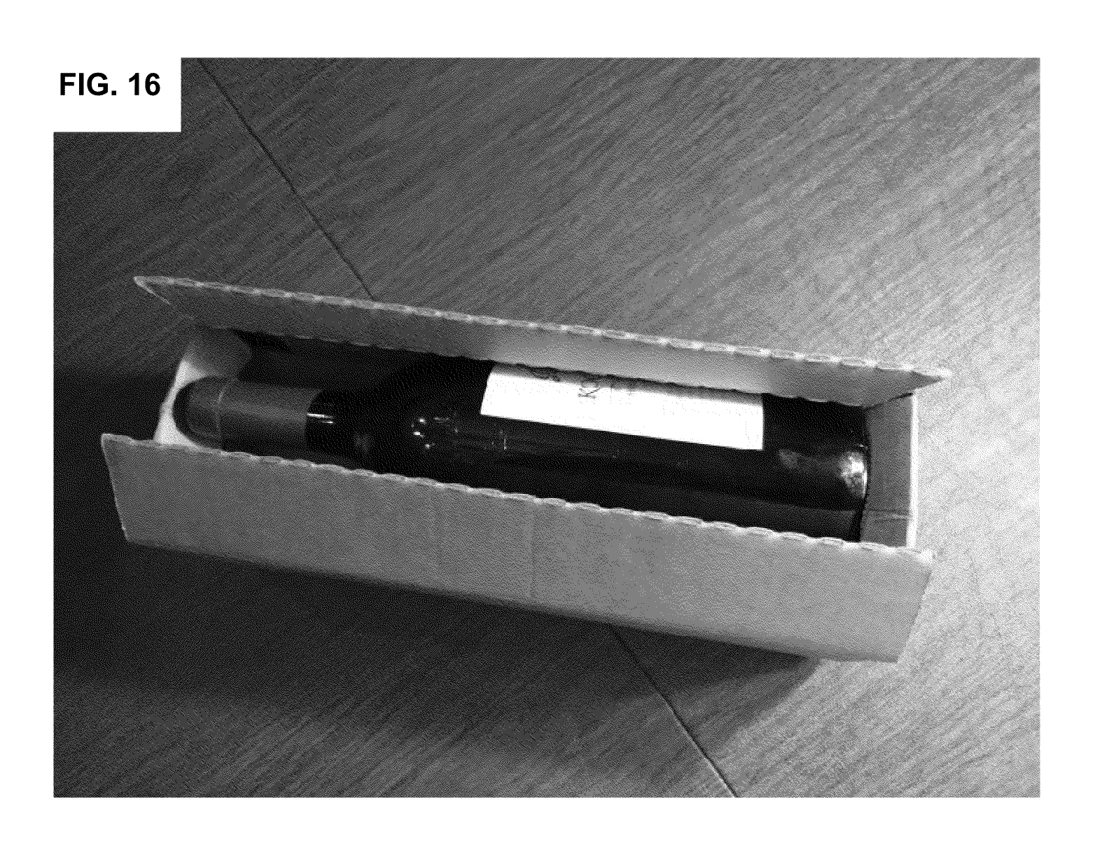

FIG. 16 shows the box of FIG. 9, wherein a bottle of wine is suspended in a cradled position within the interior of the body of the box.

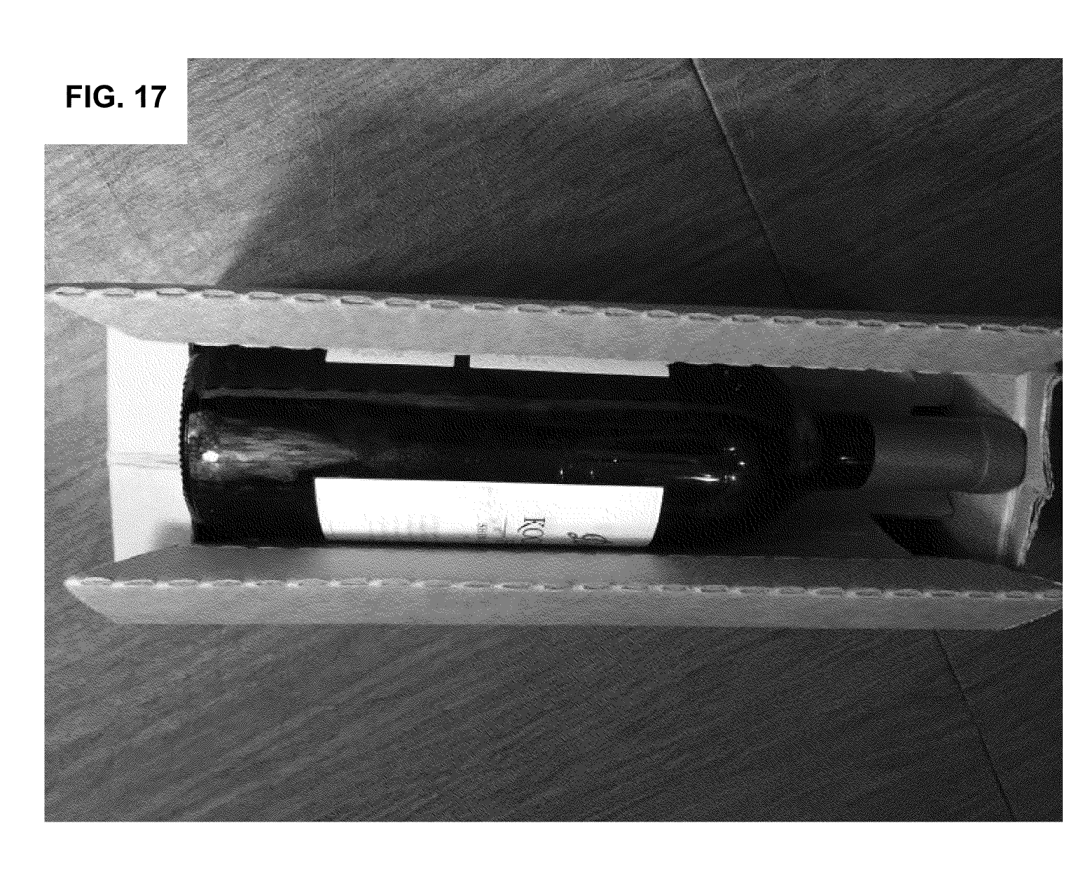

FIG. 17 is a view similar to that of FIG. 16.

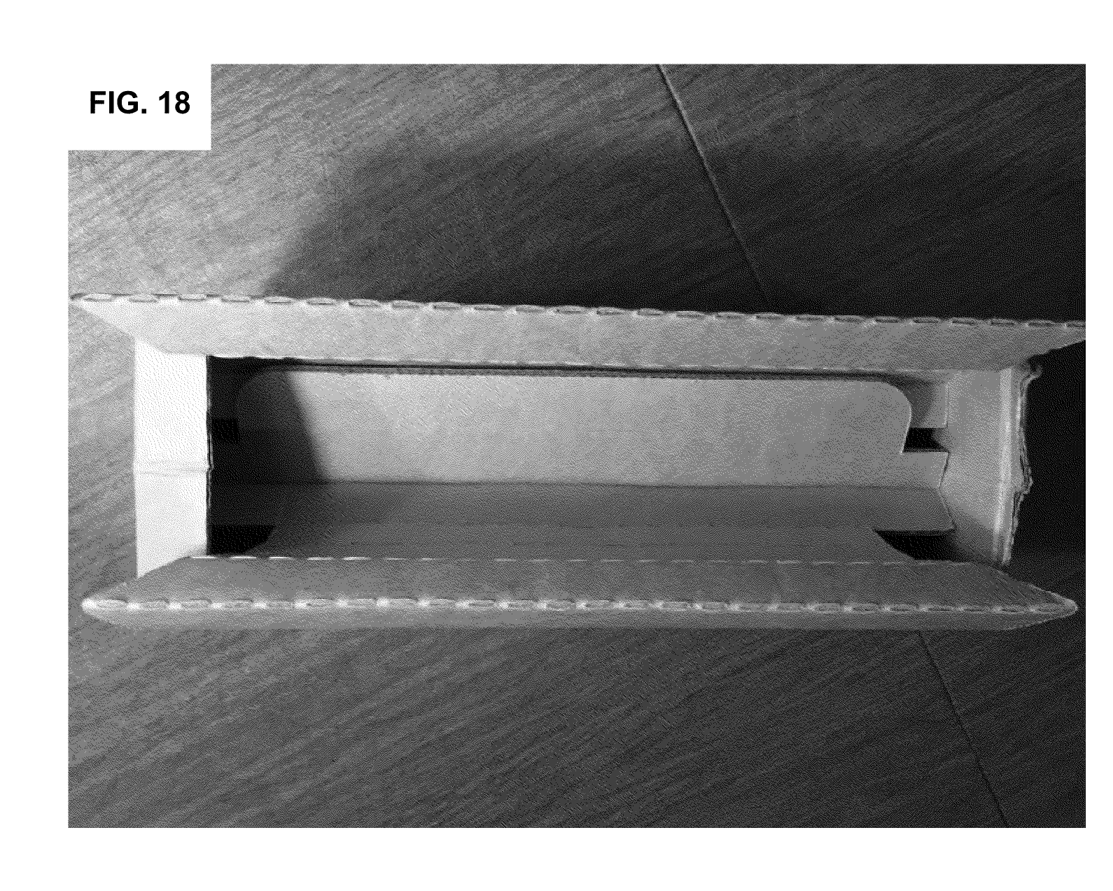

FIG. 18 shows the box of FIG. 17 with the bottle removed; it will be appreciated that the top panel of the top portion forms a floor of the cradle for receiving and suspending the bottle.

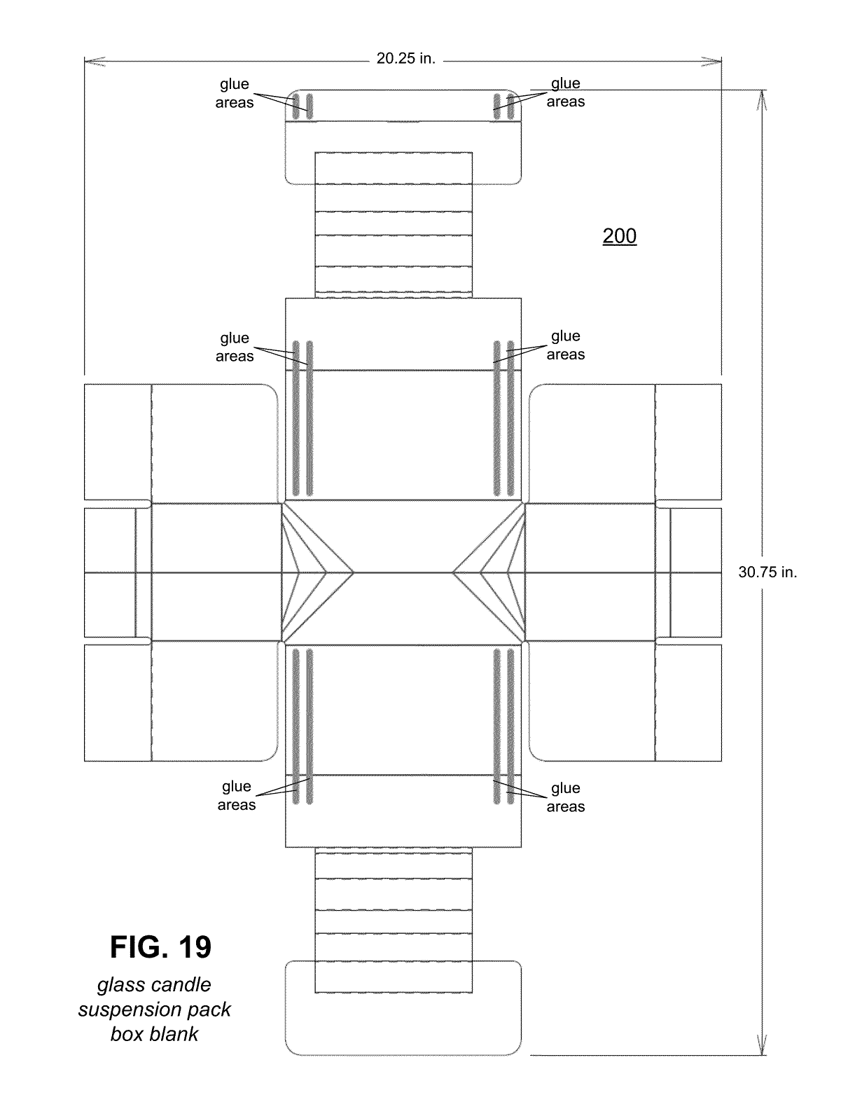

FIG. 19 is a schematic illustration of a preferred box blank in accordance with one or more aspects and features of the present invention; the blank represented in FIG. 19 is designed and dimensioned to accommodate the shipping of a glass candle, or plurality of stacked glass candles. FIG. 19 additionally shows the score or fold lines as well as the areas at which glue is applied when assembling the box by folding using the methods and machines generally disclosed in U.S. patent application publication 2012/0238423, incorporated by reference herein.

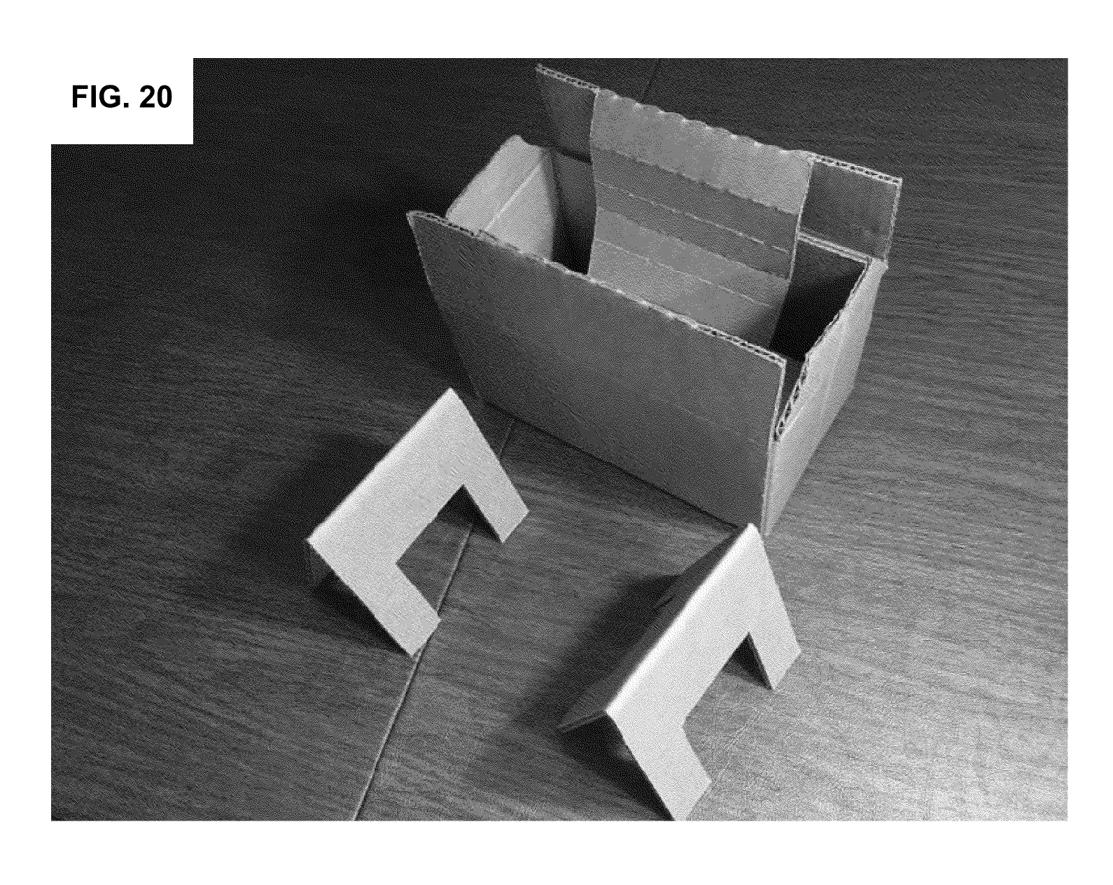

FIG. 20 shows a prototype of a box that has been assembled by folding and gluing the box blank of FIG. 19, wherein the assembled box is in an expanded configuration ready to receive an item. FIG. 20 additionally shows two inserts that may be used with the box for stabilizing the item when received and suspended within the box.

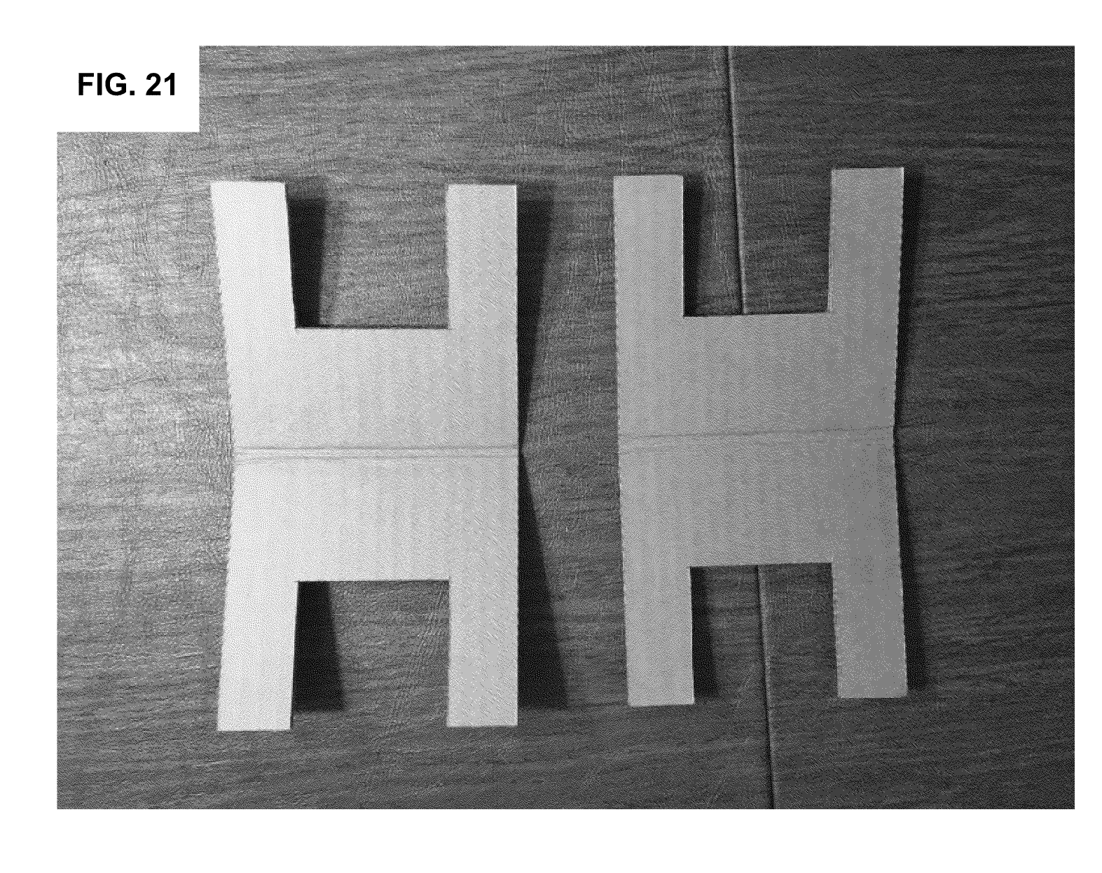

FIG. 21 shows the two inserts of FIG. 20 each in an unfolded, generally flat state.

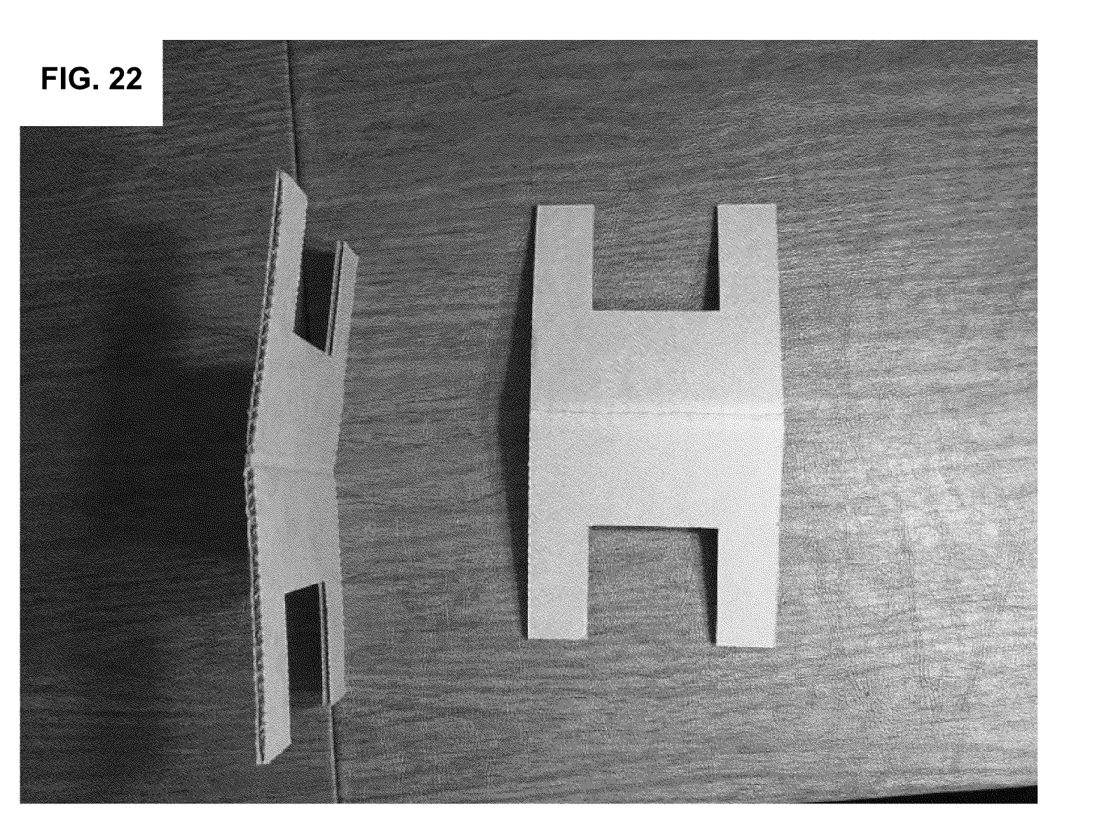

FIG. 22 shows the inserts of FIG. 21, wherein one of the inserts has been turned to show the generally flat profile of the inserts. When folded over about the hinge line that bisects each inert, the insert becomes a two-ply stabilizer.

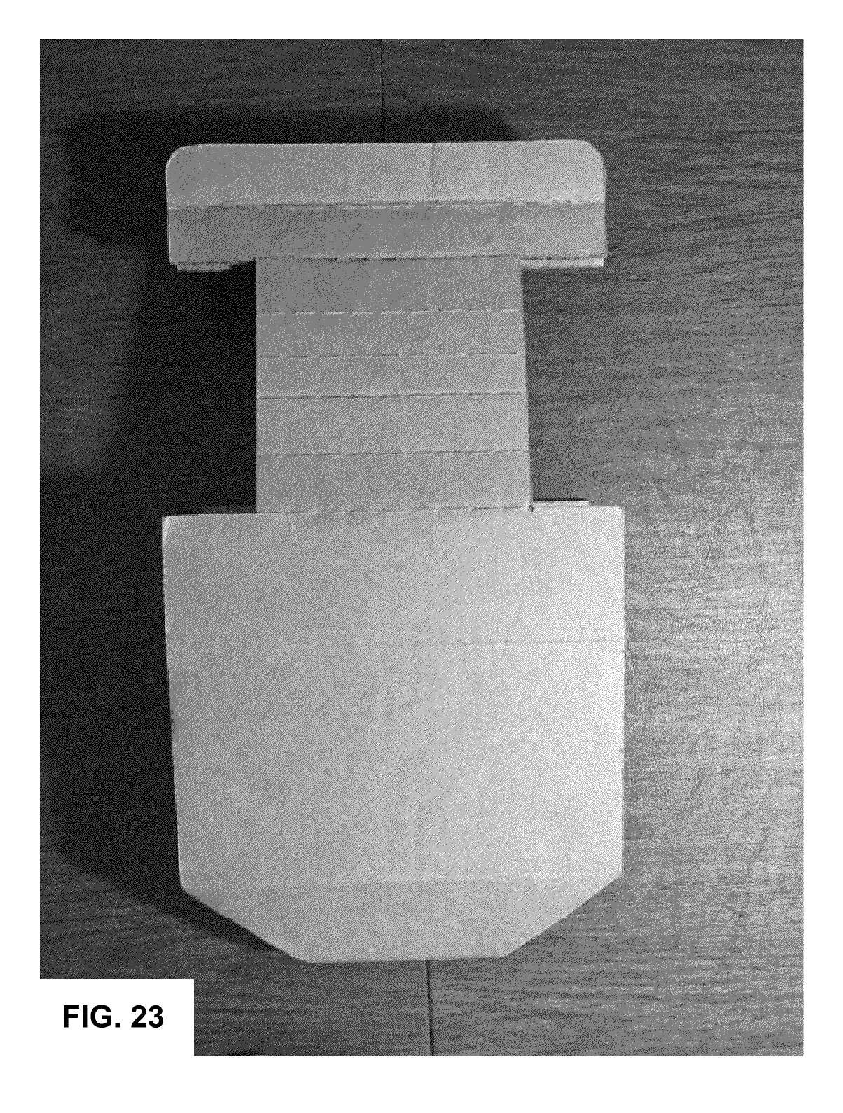

FIG. 23 shows a first side of the assembled box of FIG. 20 in a collapsed configuration with a top portion in an extended position.

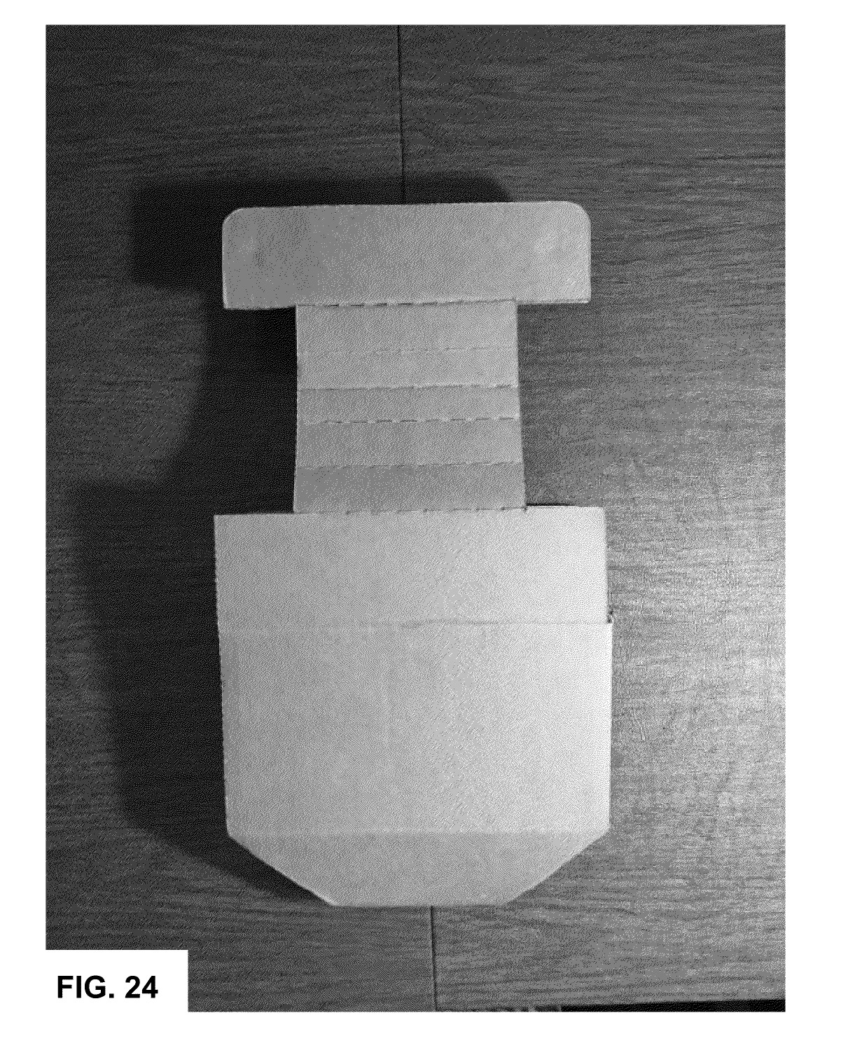

FIG. 24 shows the other side of the box of FIG. 23, wherein the assembled box is in a collapsed, folded configuration with a top portion in an extended position.

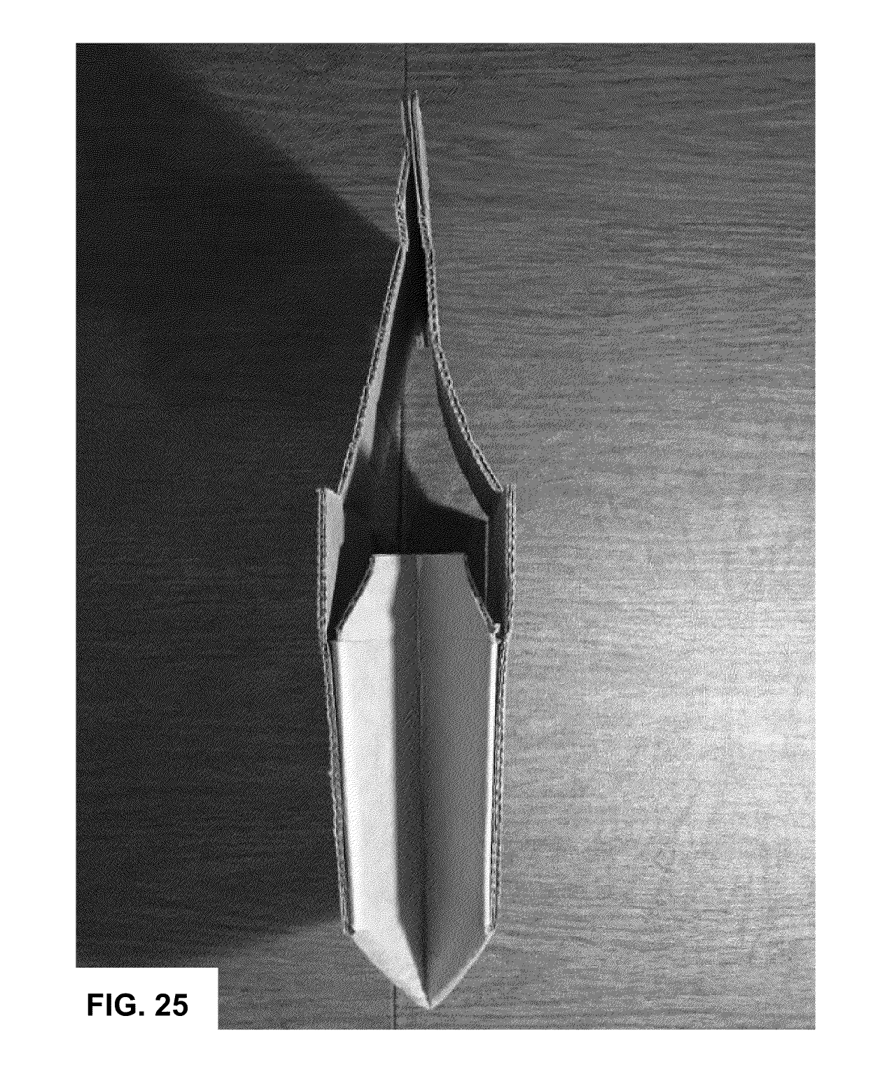

FIG. 25 shows an end of the box of FIG. 23, wherein the assembled box is in a collapsed, folded configuration with a top portion in an extended position.

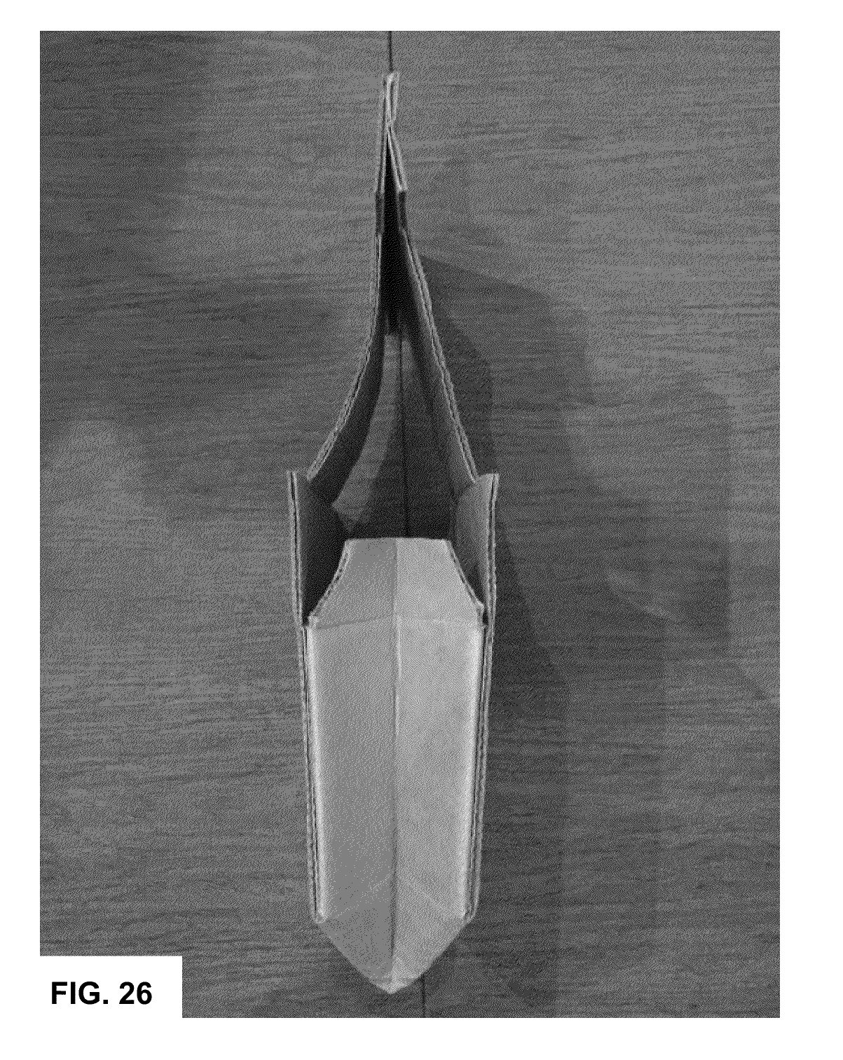

FIG. 26 shows another end of the box of FIG. 23, wherein the assembled box is in a collapsed, folded configuration with a top portion in an extended position.

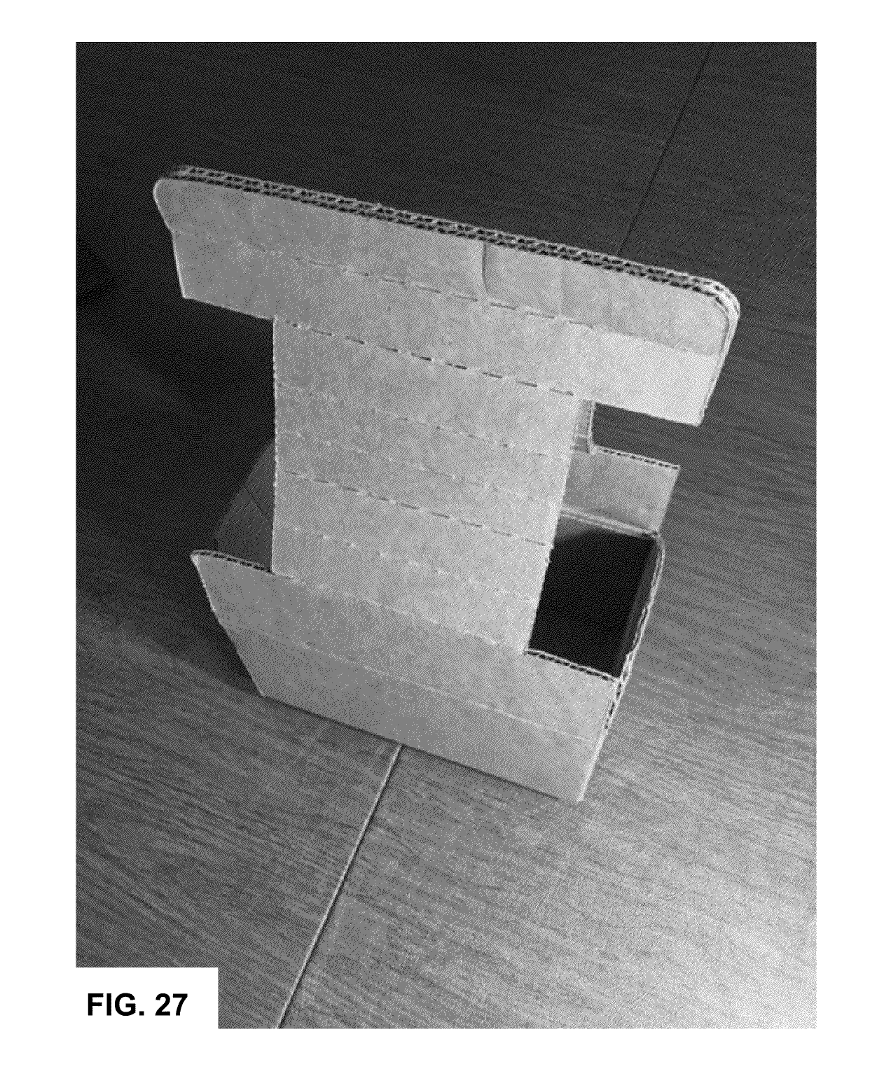

FIG. 27 shows the box of FIGS. 23-26 after expanding the body of the box, with a top portion of the box remaining in an extended position.

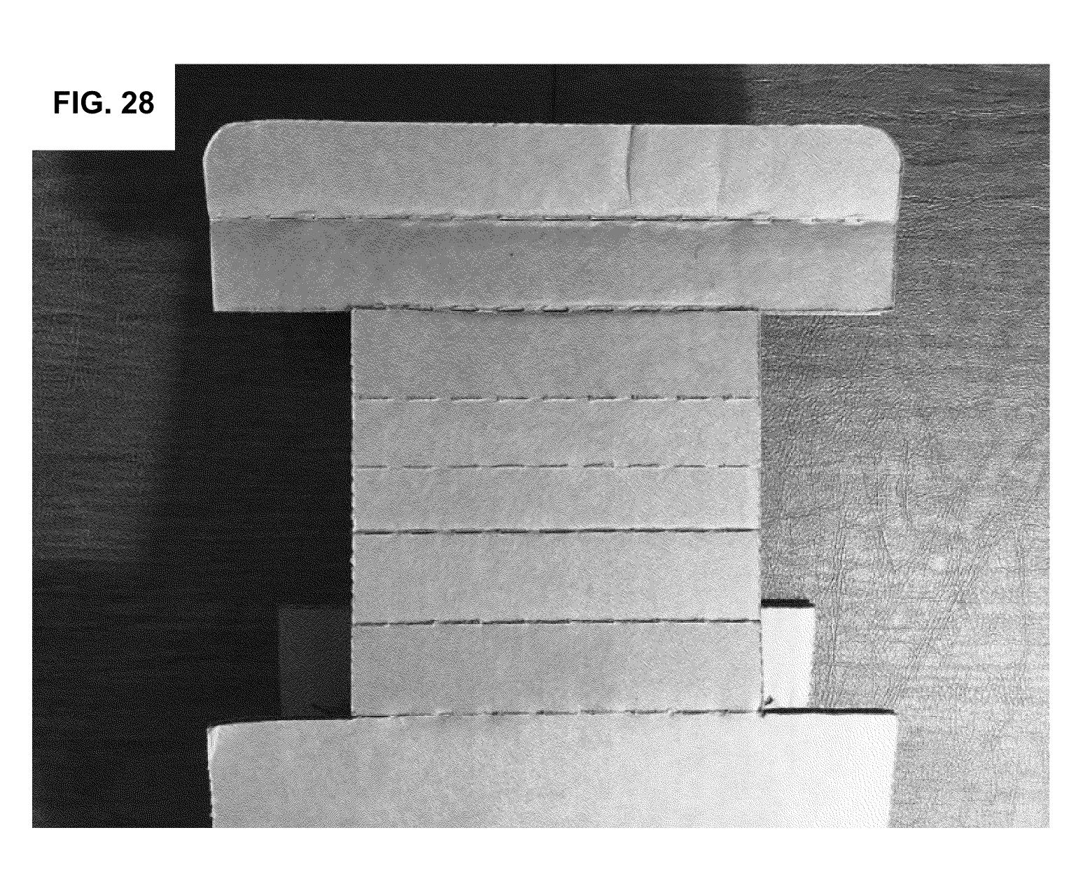

FIG. 28 is a closer view of a side of the top portion of the box of FIG. 27.

FIG. 28 is a closer view of a side of the top portion of the box of FIG. 27.

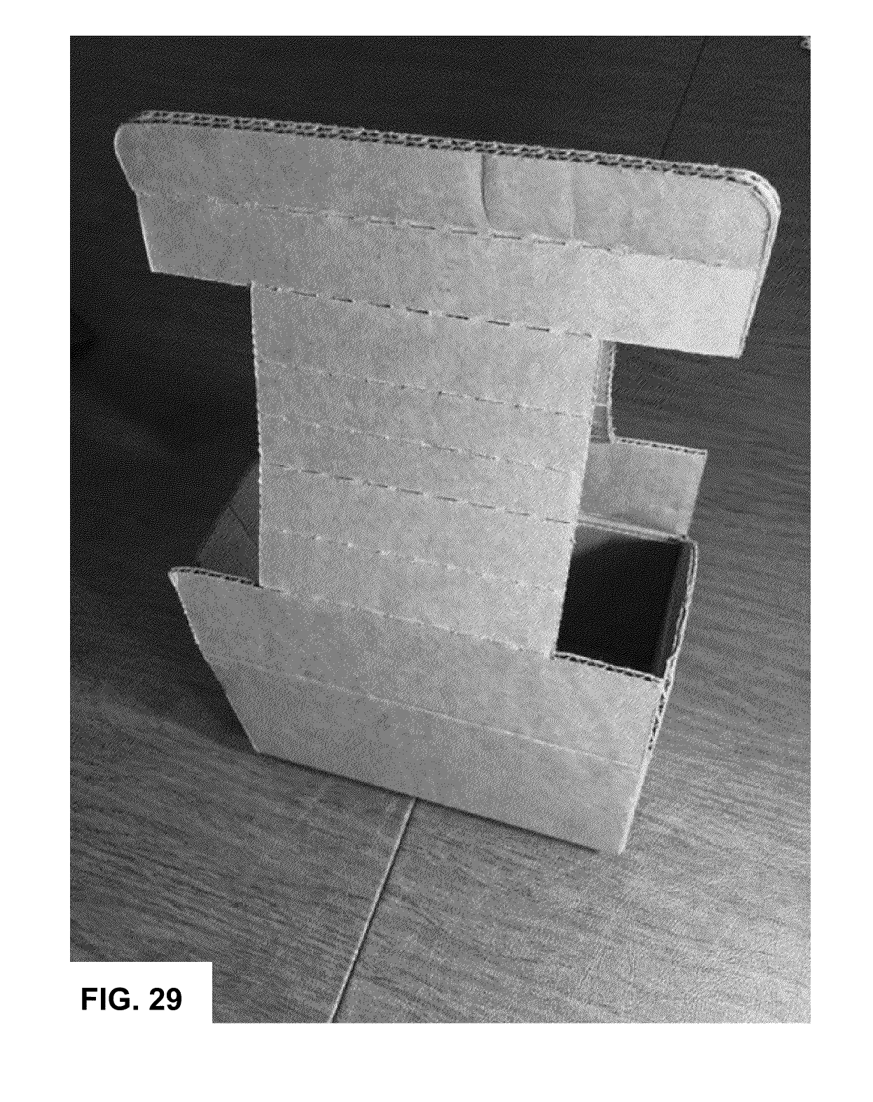

FIG. 29 is another view similar to that of FIG. 27.

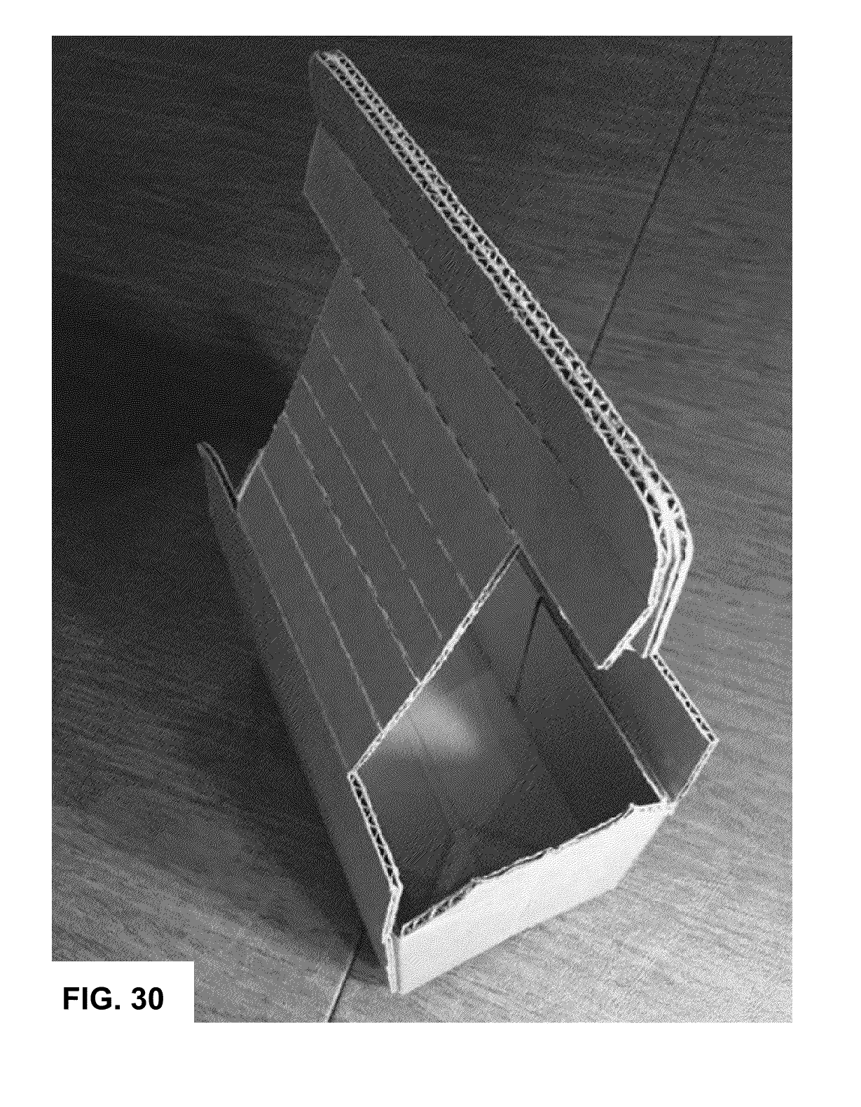

FIG. 30 is another view similar to that of FIG. 27.

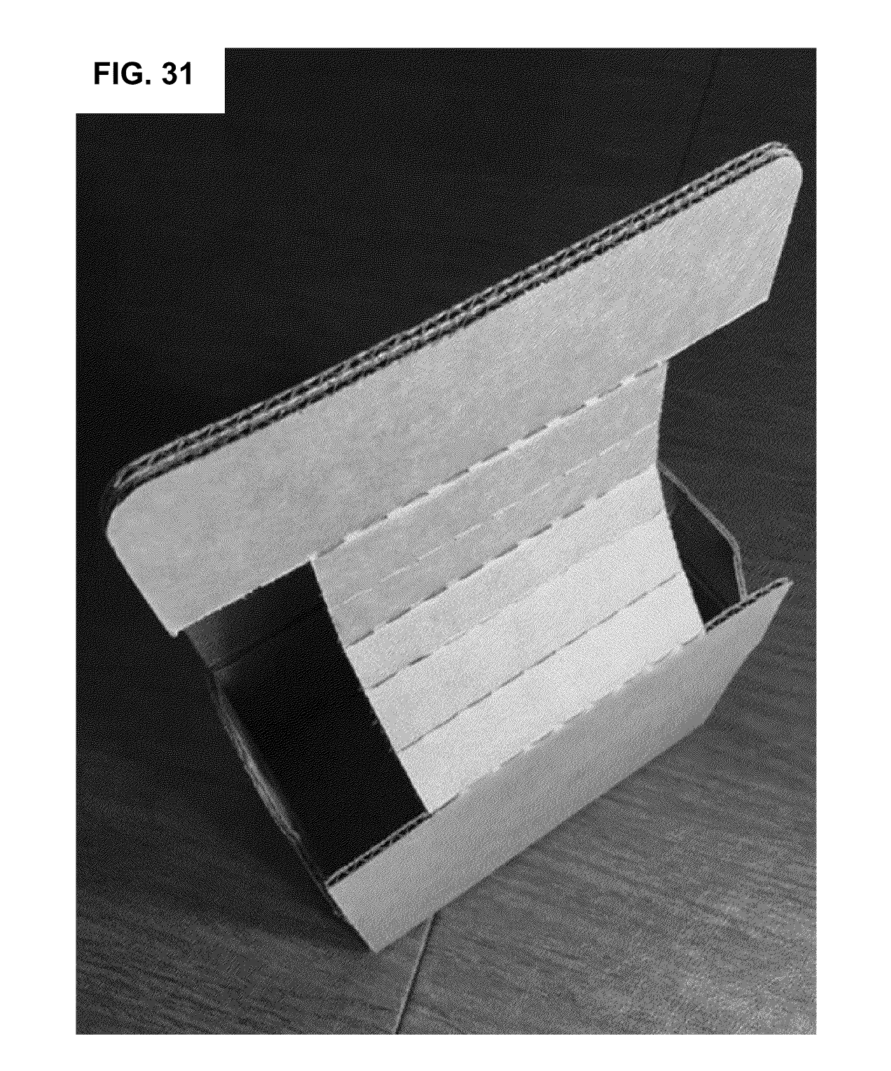

FIG. 31 is another view similar to that of FIG. 27, but of an opposite side of the box to the side shown in FIG. 27.

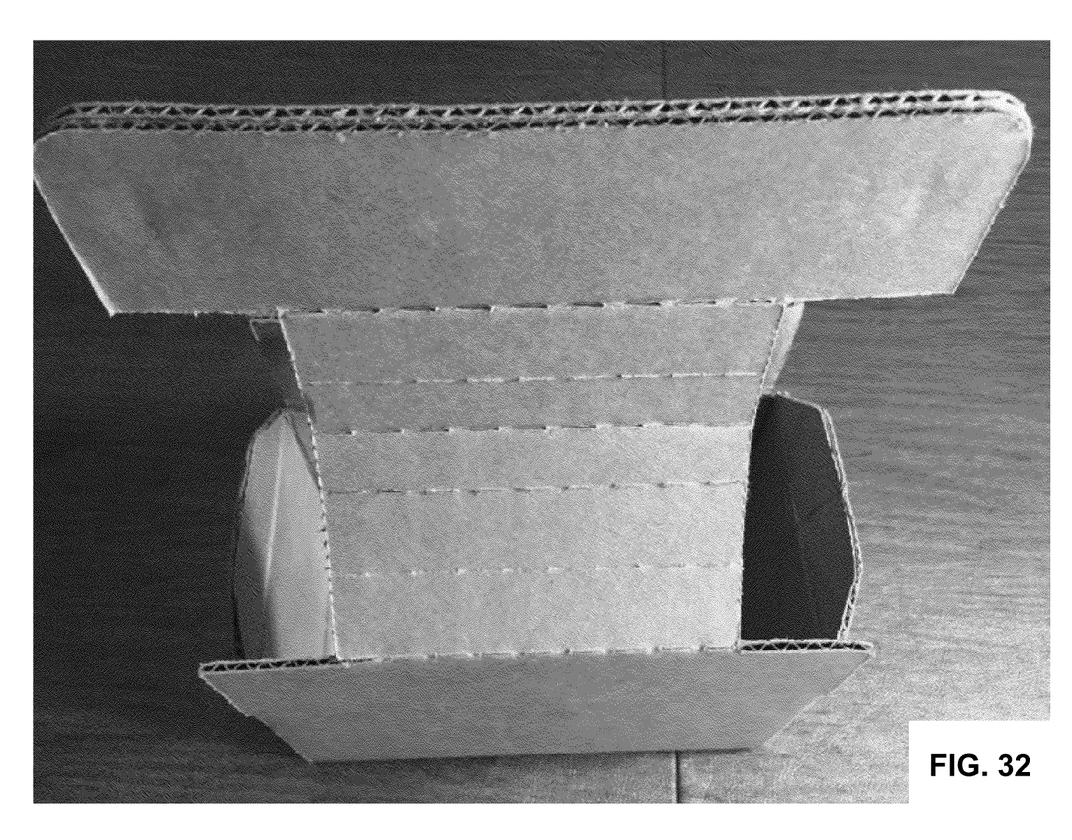

FIG. 32 is another view similar to that of FIG. 31.

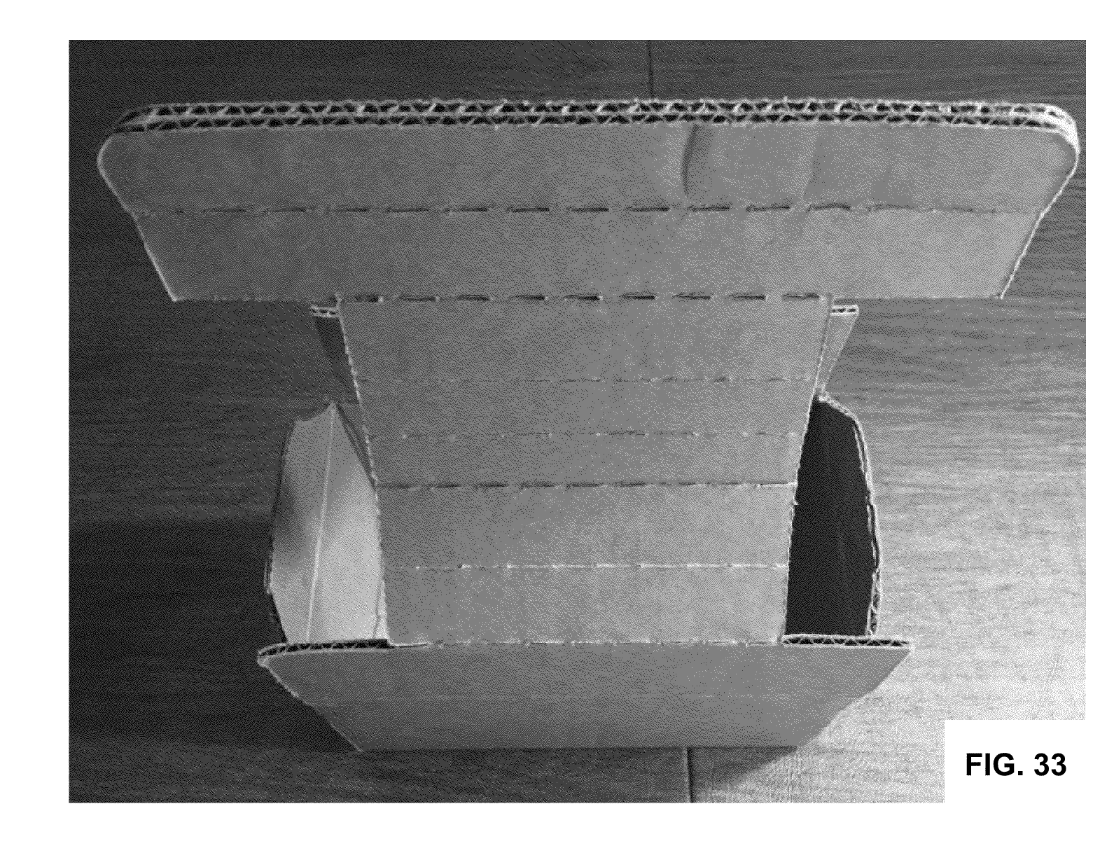

FIG. 33 is another view similar to that of FIG. 32, but of the opposite side of the box.

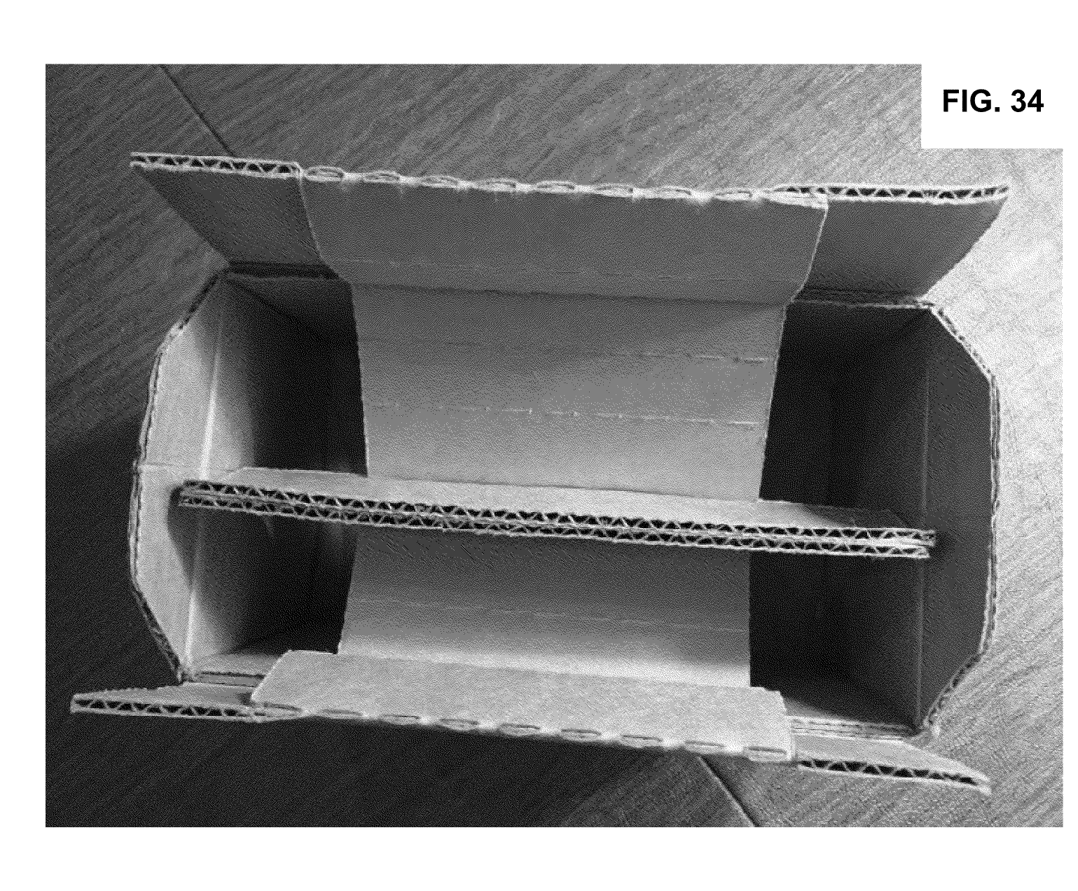

FIG. 34 shows the box of FIG. 33 with the top portion of the box in an intermediate position during folding of the top portion into the interior of the body of the box.

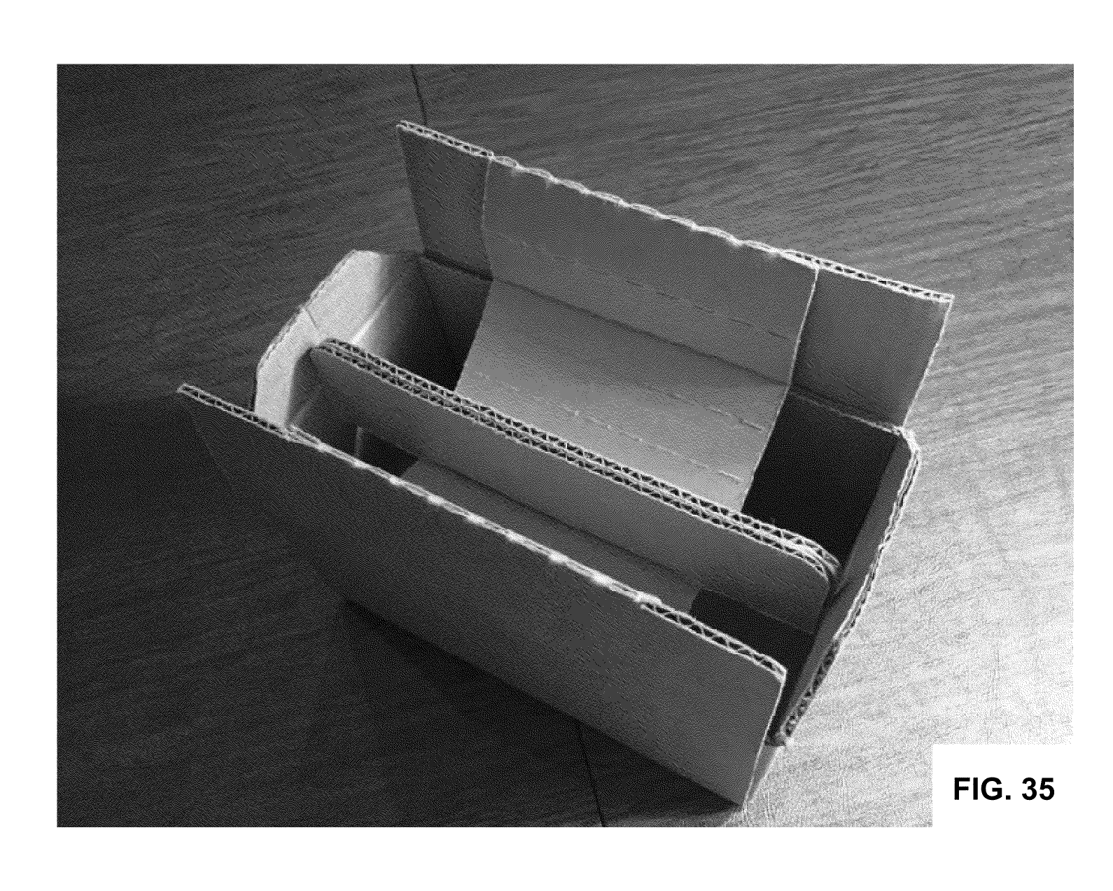

FIG. 35 is another view similar to that of FIG. 34.

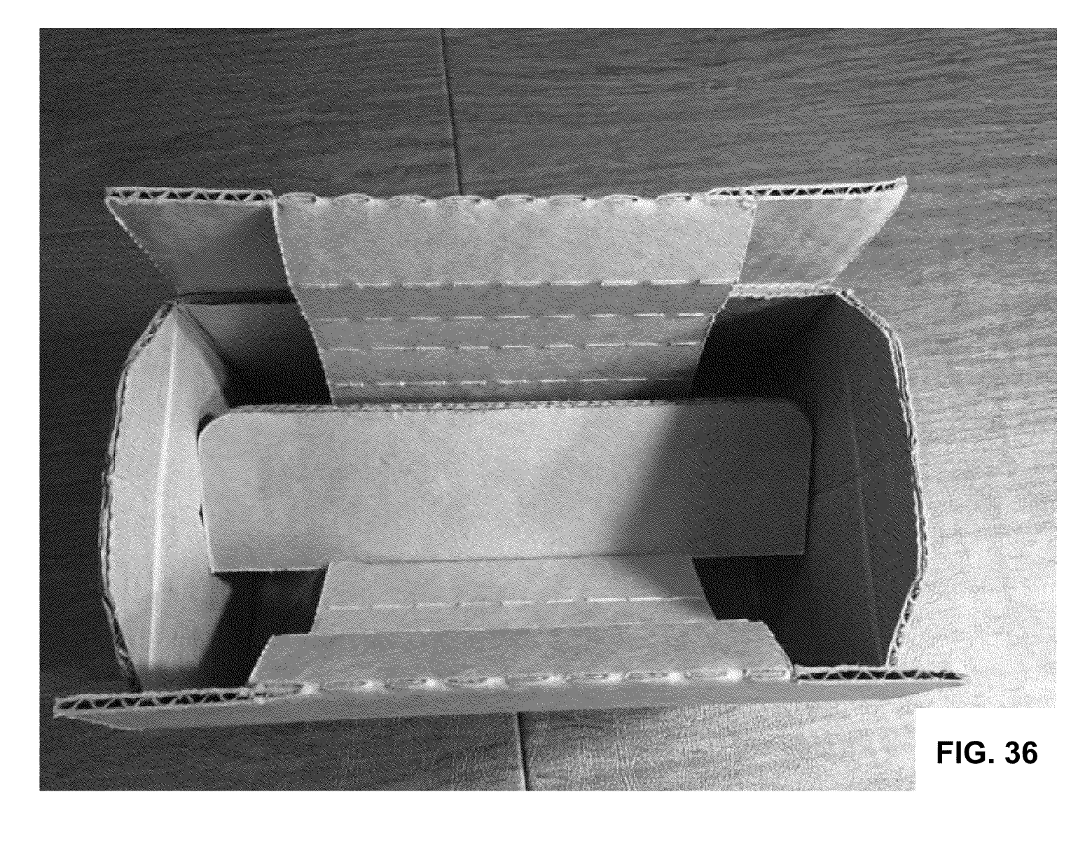

FIG. 36 shows the box of FIG. 35 with the top portion of the box having been folded below the top of the lids into the interior of the body of the box, and with a top panel of the top portion having been folded down to form a bottom of the cradle for suspending of an item within the interior of the box.

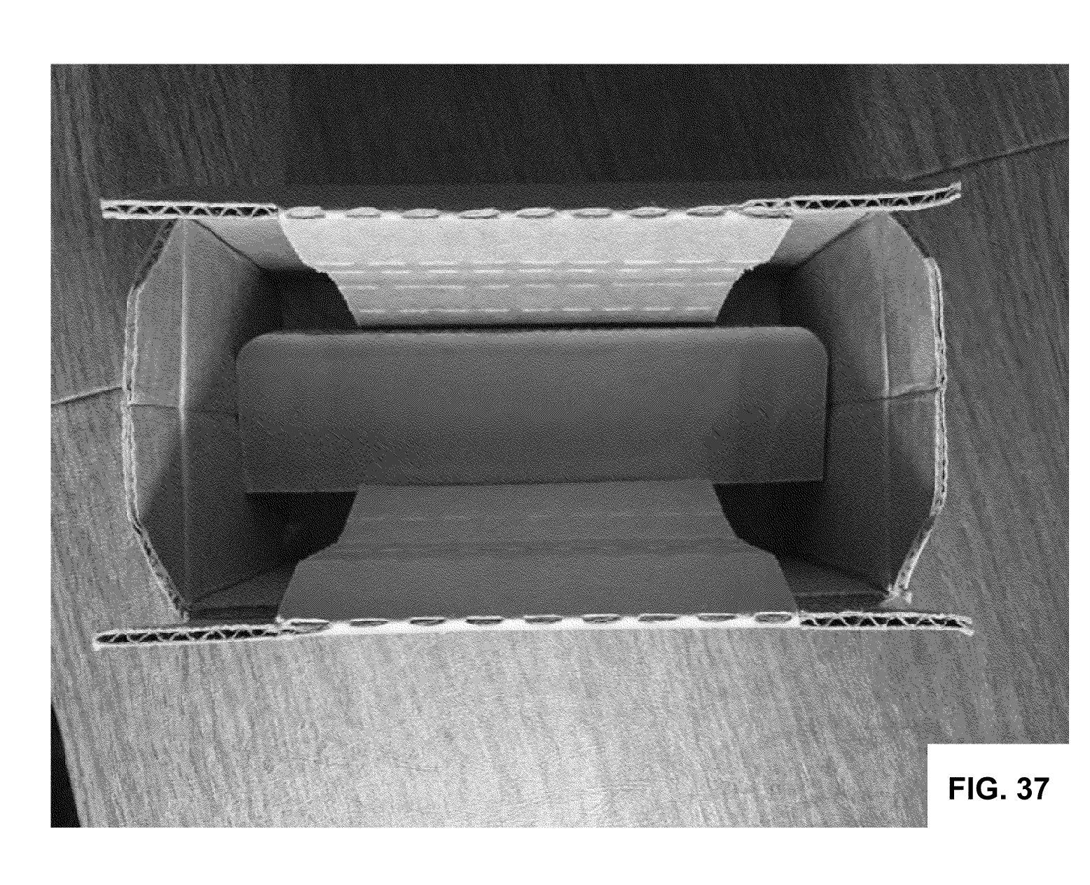

FIG. 37 is another view similar to that of FIG. 36.

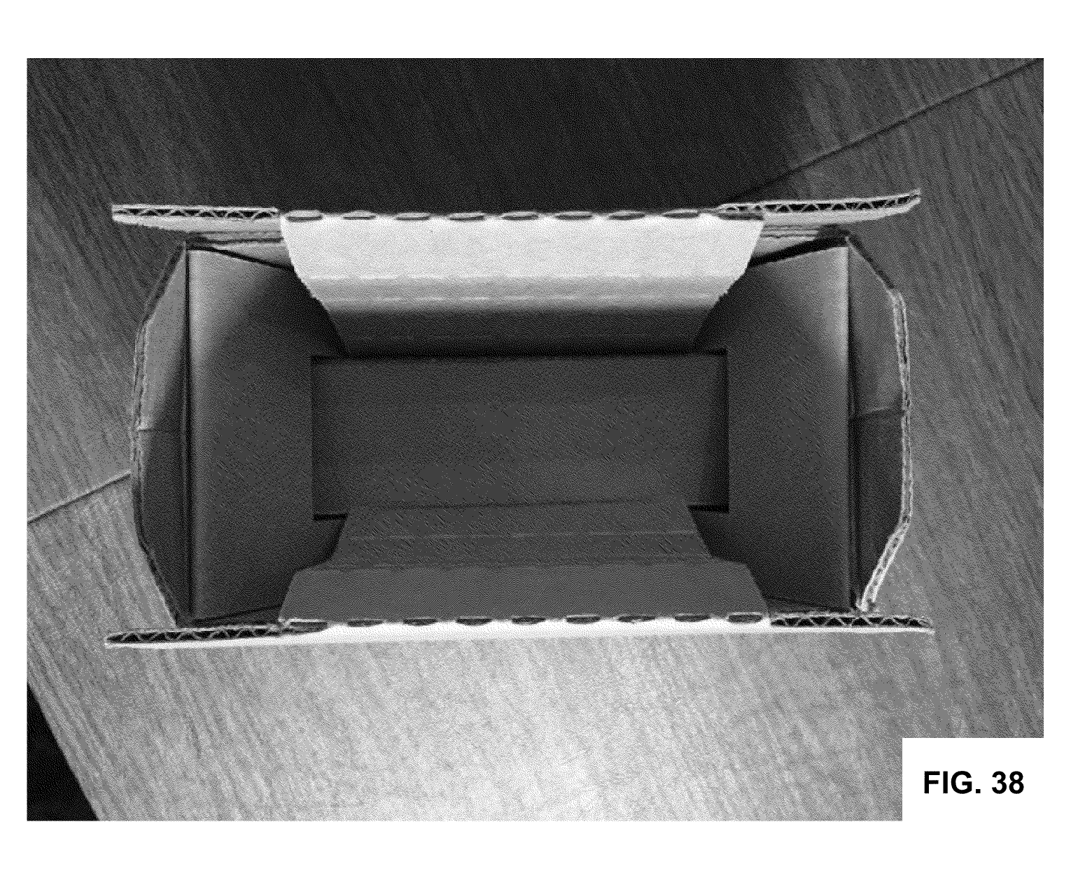

FIG. 38 is another view similar to that of FIG. 37, wherein the two inserts have been installed within the interior of the body of the box adjacent end walls of the box.

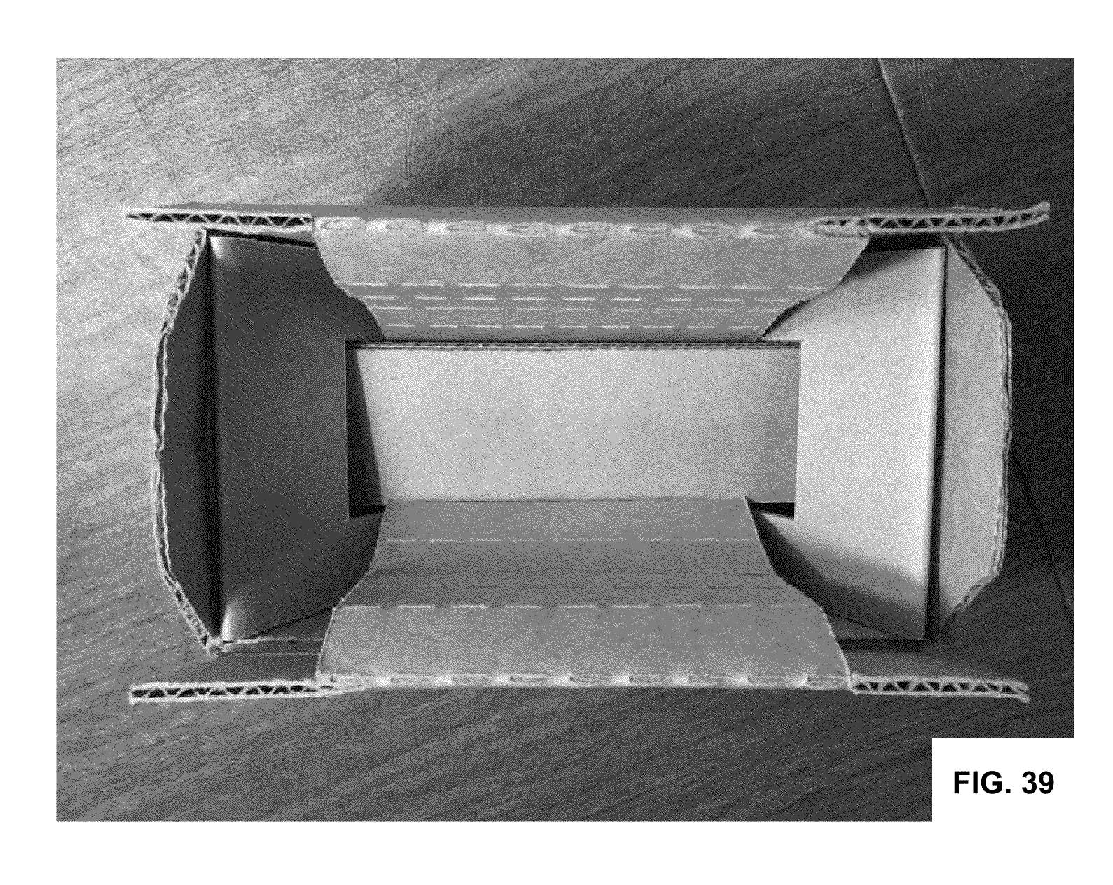

FIG. 39 is another view similar to that of FIG. 38.

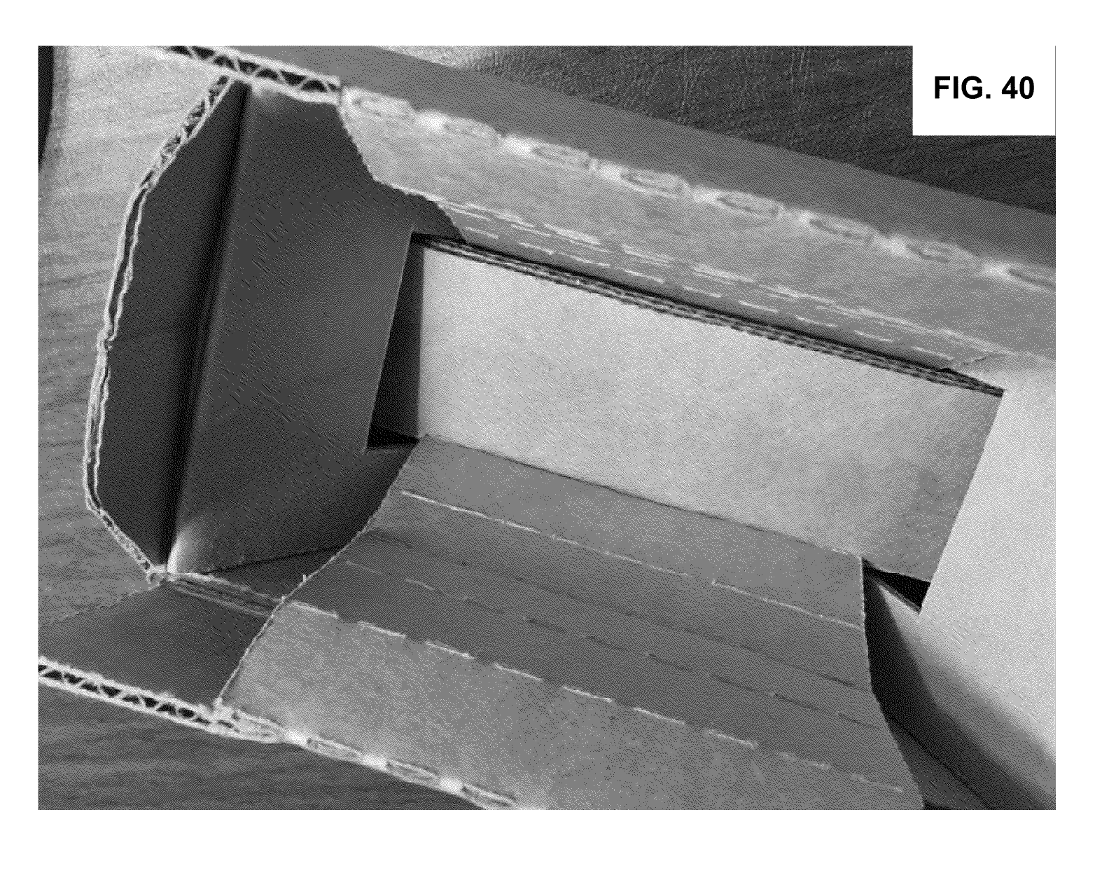

FIG. 40 is another view similar to that of FIG. 39.

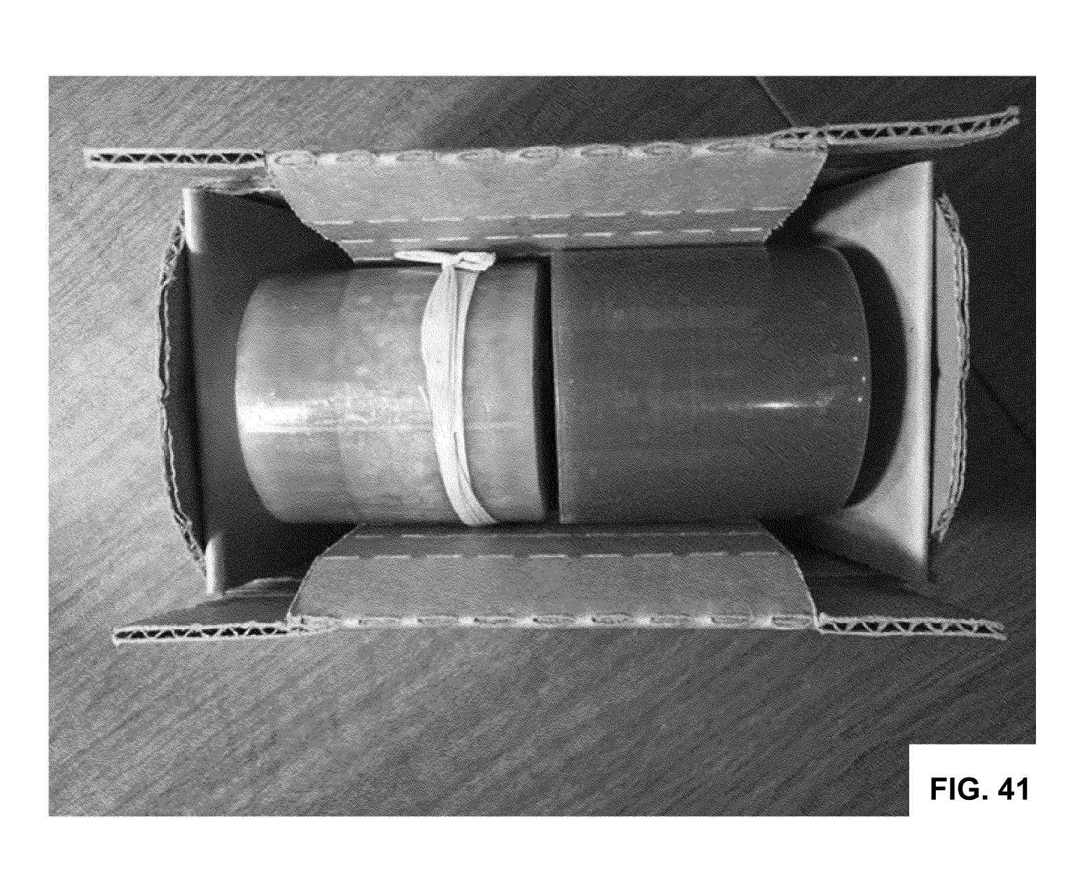

FIG. 41 is a view of the box of FIG. 36, wherein two candles are received in a stacked formation within the interior of the body of the box and are suspended therein.

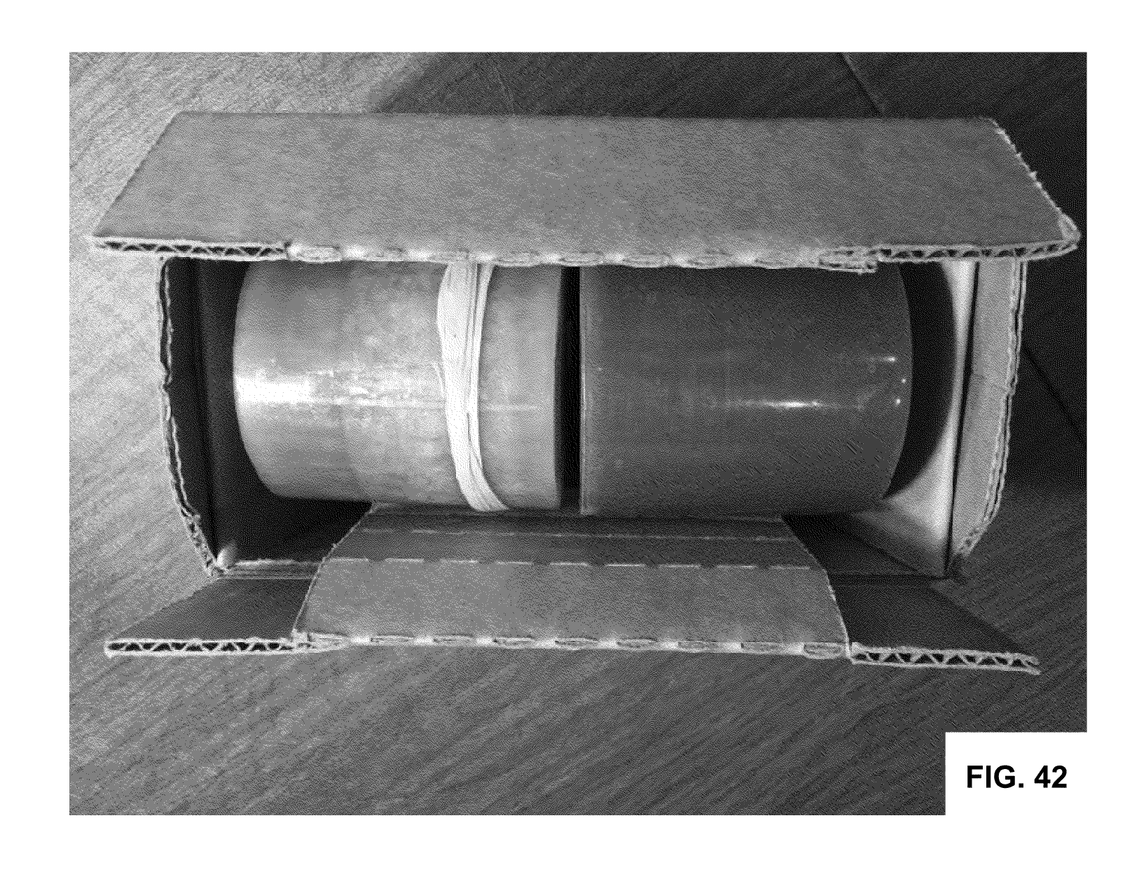

FIG. 42 is another view similar to that of FIG. 41.

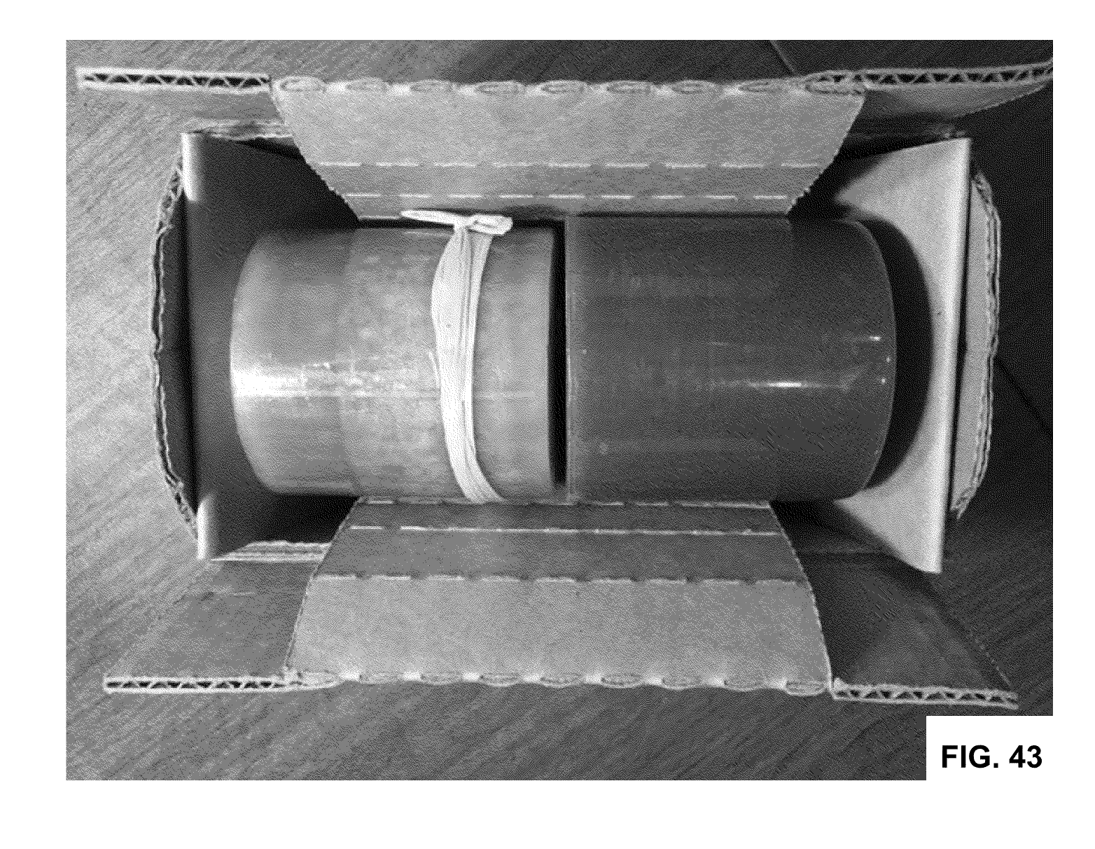

FIG. 43 is another view similar to that of FIG. 41.

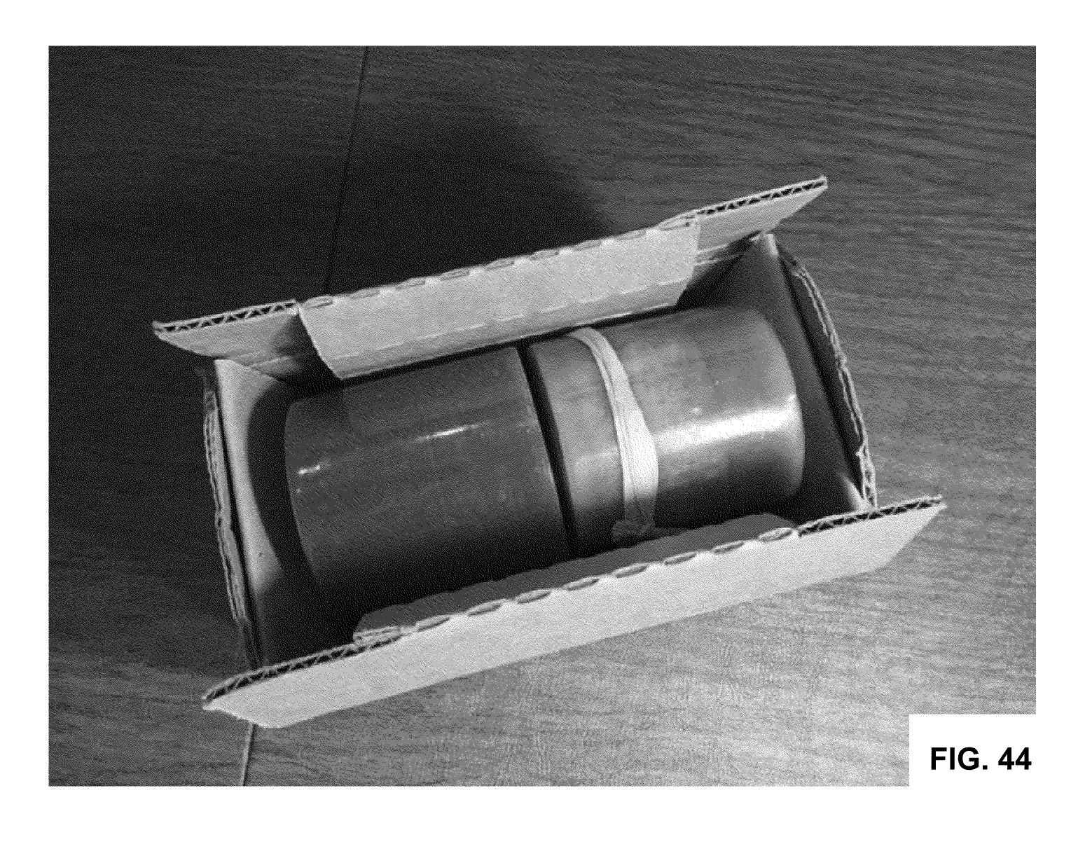

FIG. 45 is another view similar to that of FIG. 41, wherein the lids are being closed.

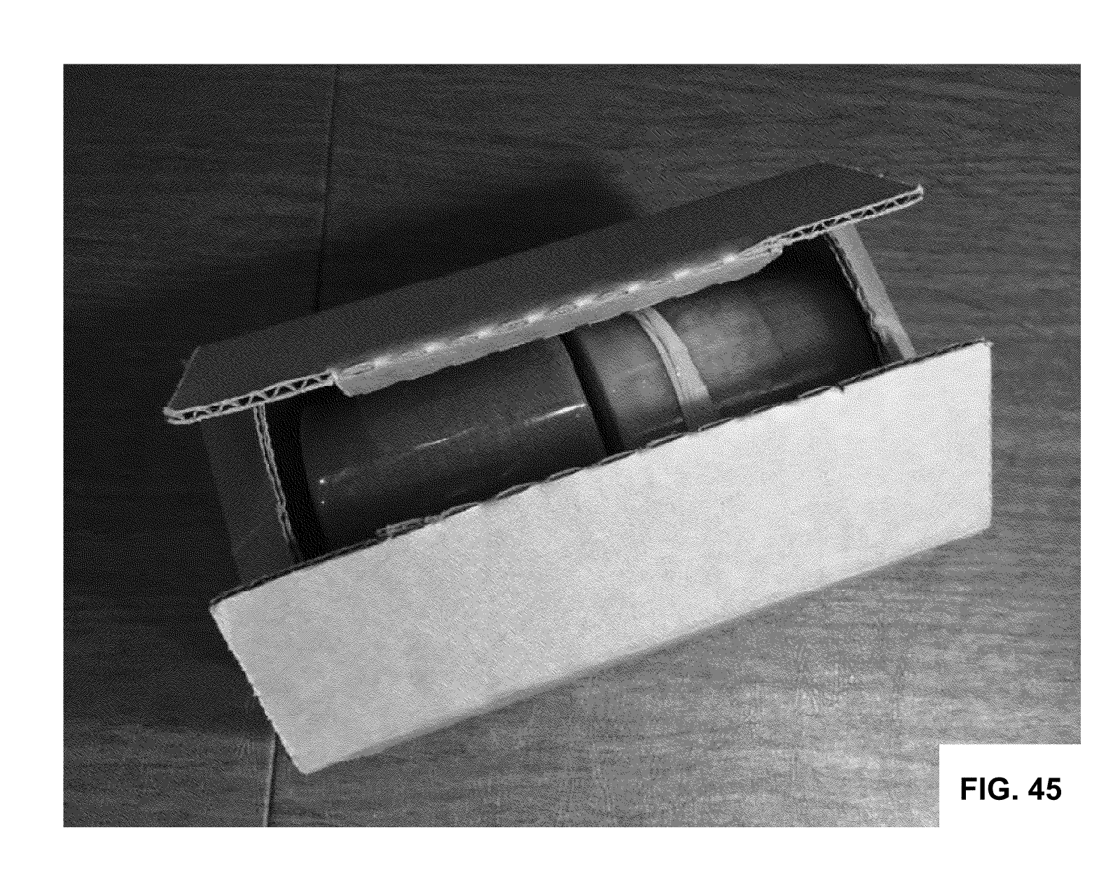

FIG. 46 is another view similar to that of FIG. 41, wherein the lids are closed and ready for taping.

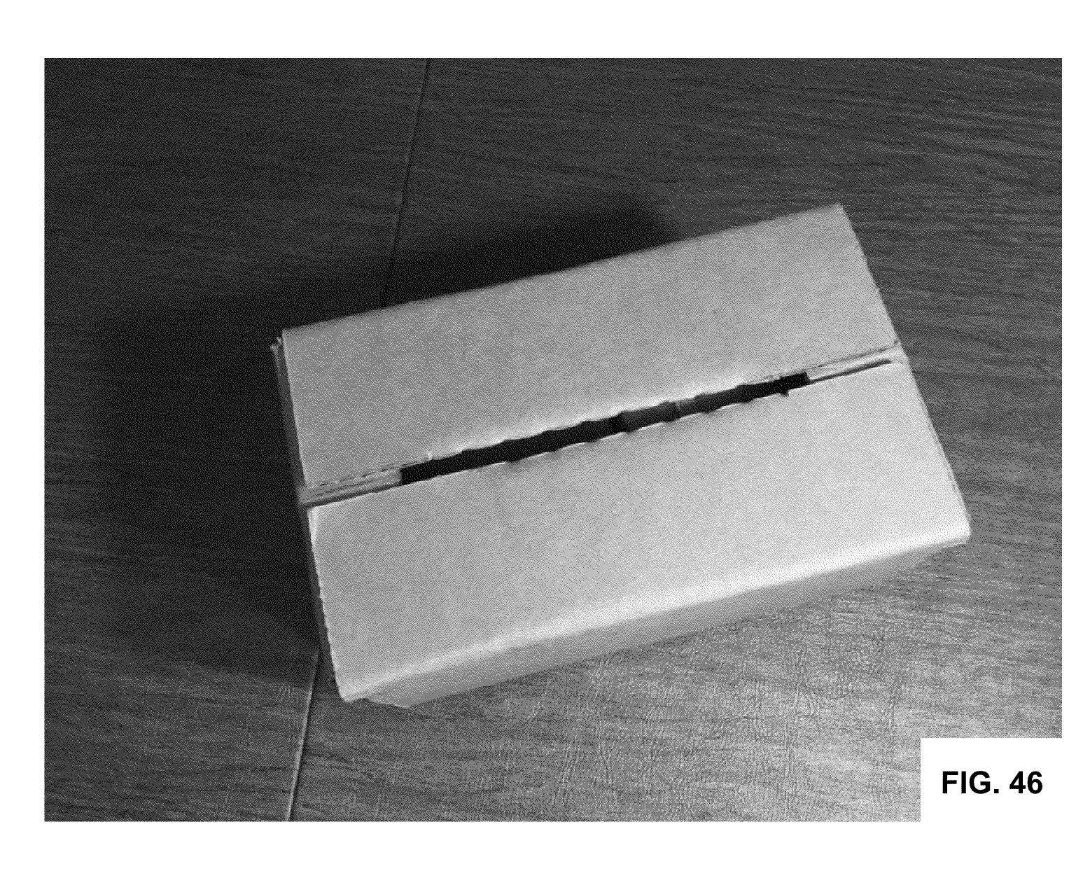

FIG. 47 is a schematic illustration of a preferred box blank in accordance with one or more aspects and features of the present invention; the blank represented in FIG. 47 is designed and dimensioned to accommodate the shipping of a cell phone, iPhone, iPod, or other similarly sized electronic device. FIG. 47 additionally shows the score or fold lines as well as the areas at which glue is applied when assembling the box by folding using the methods and machines generally disclosed in U.S. patent application publication 2012/0238423, incorporated by reference herein.

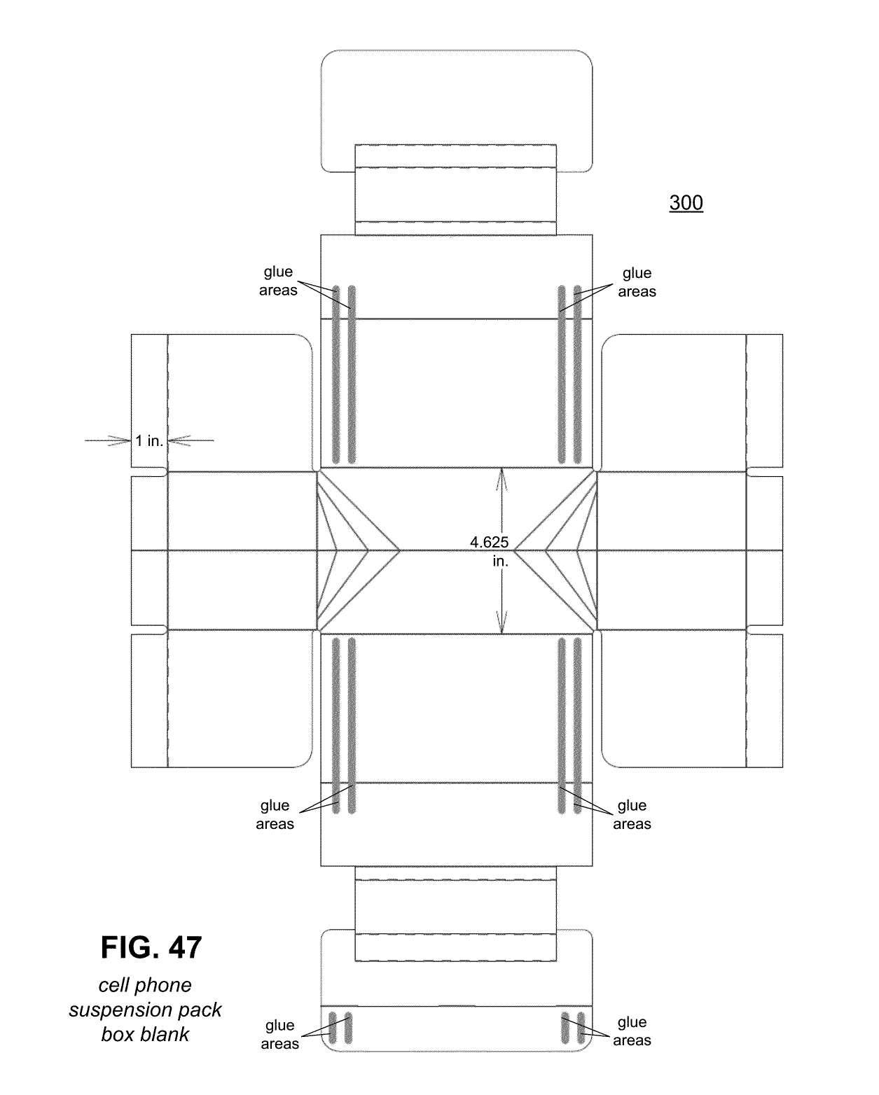

FIG. 48 shows a first side of a prototype of a box that has been assembled by folding and gluing the box blank of FIG. 47, wherein the assembled box is in a collapsed, folded configuration.

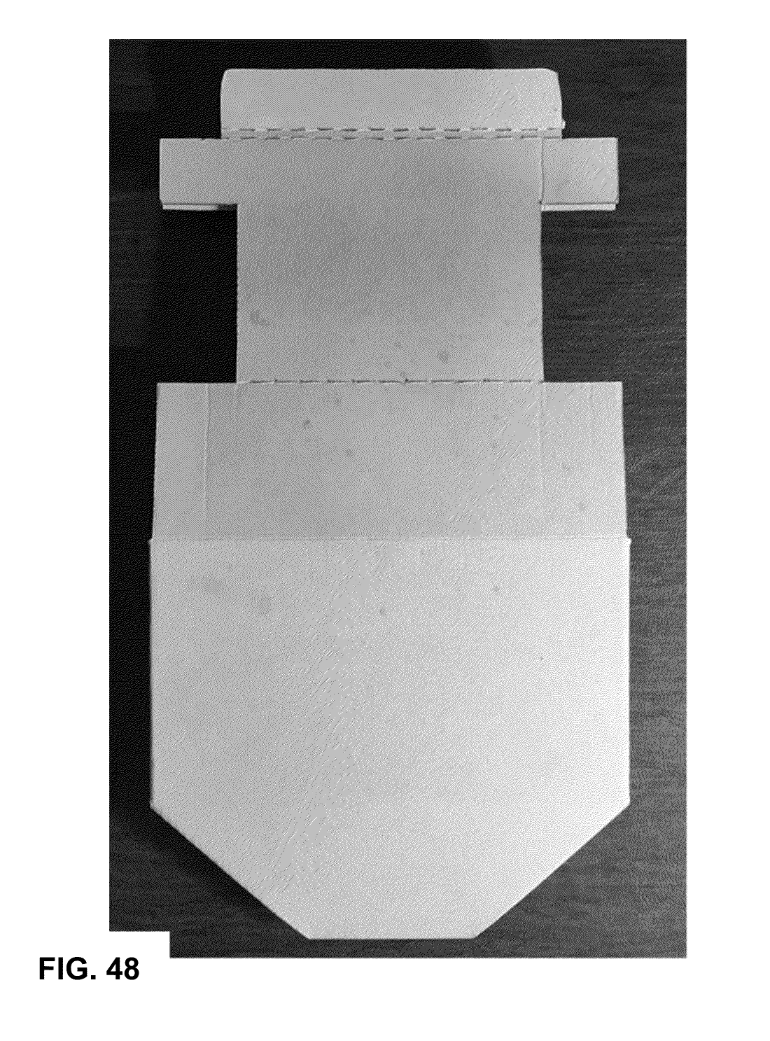

FIG. 49 shows the other side of the box of FIG. 48, wherein the assembled box is in a collapsed, folded configuration.

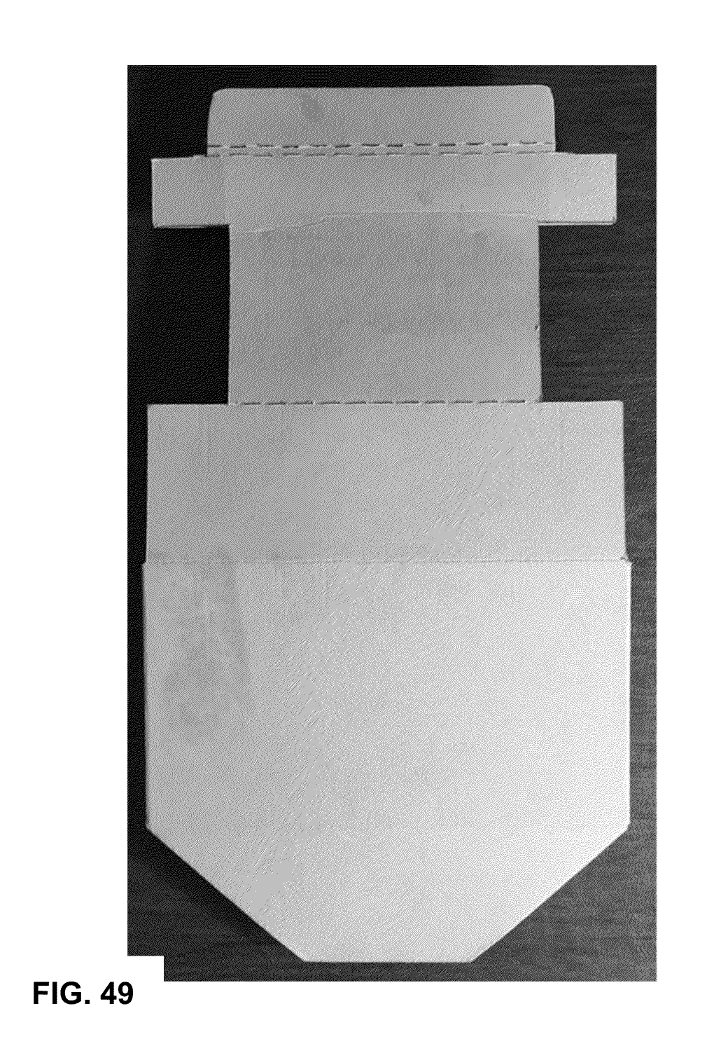

FIG. 50 shows an end of the box of FIG. 48, wherein the assembled box is in a collapsed, folded configuration.

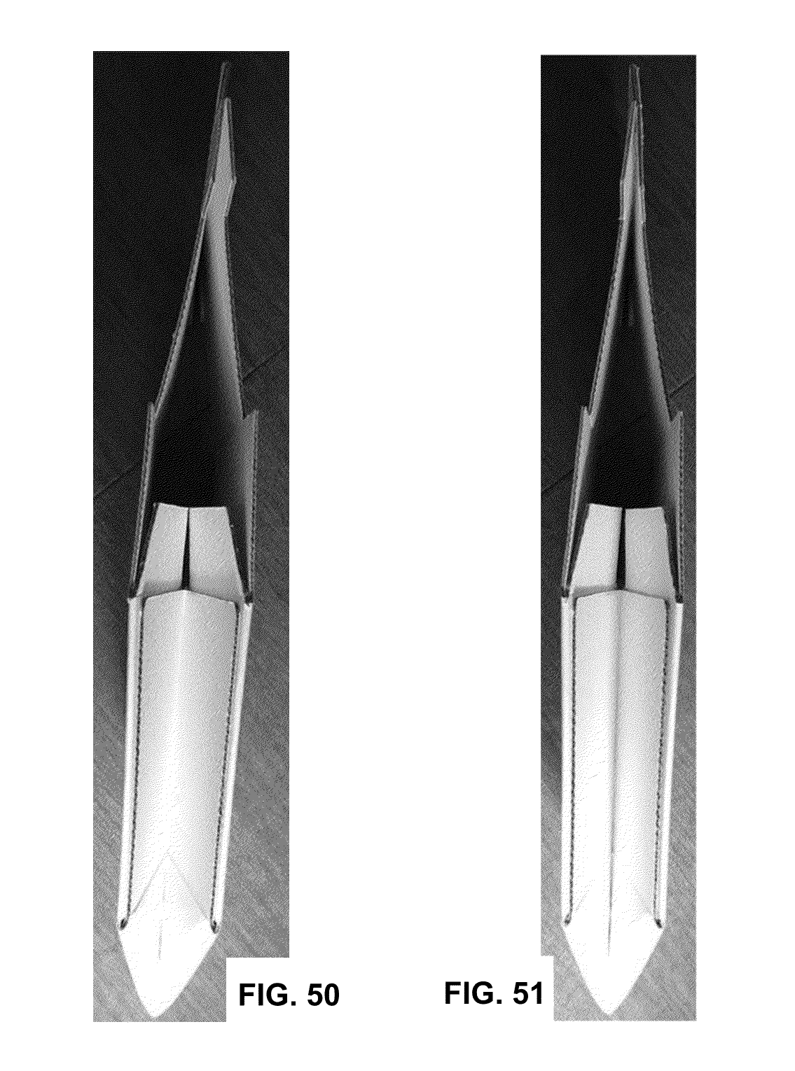

FIG. 51 shows another end of the box of FIG. 48, wherein the assembled box is in a collapsed, folded configuration.

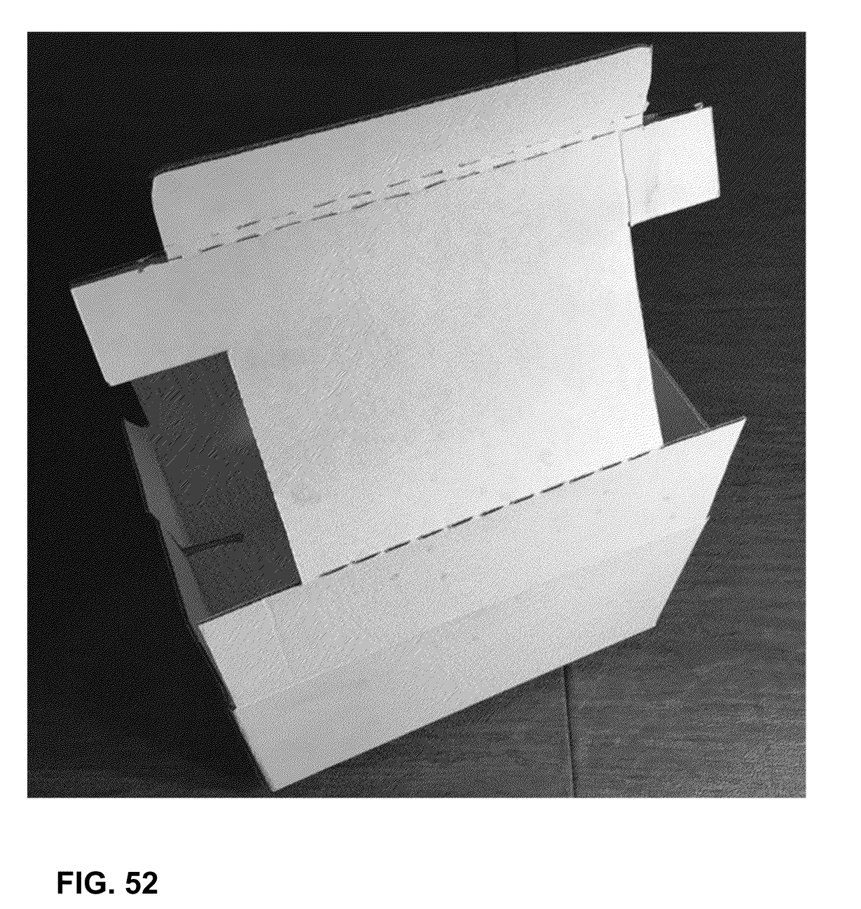

FIG. 52 shows the box of FIGS. 48-51 after expanding the body of the box, with a top portion of the box in an extended position.

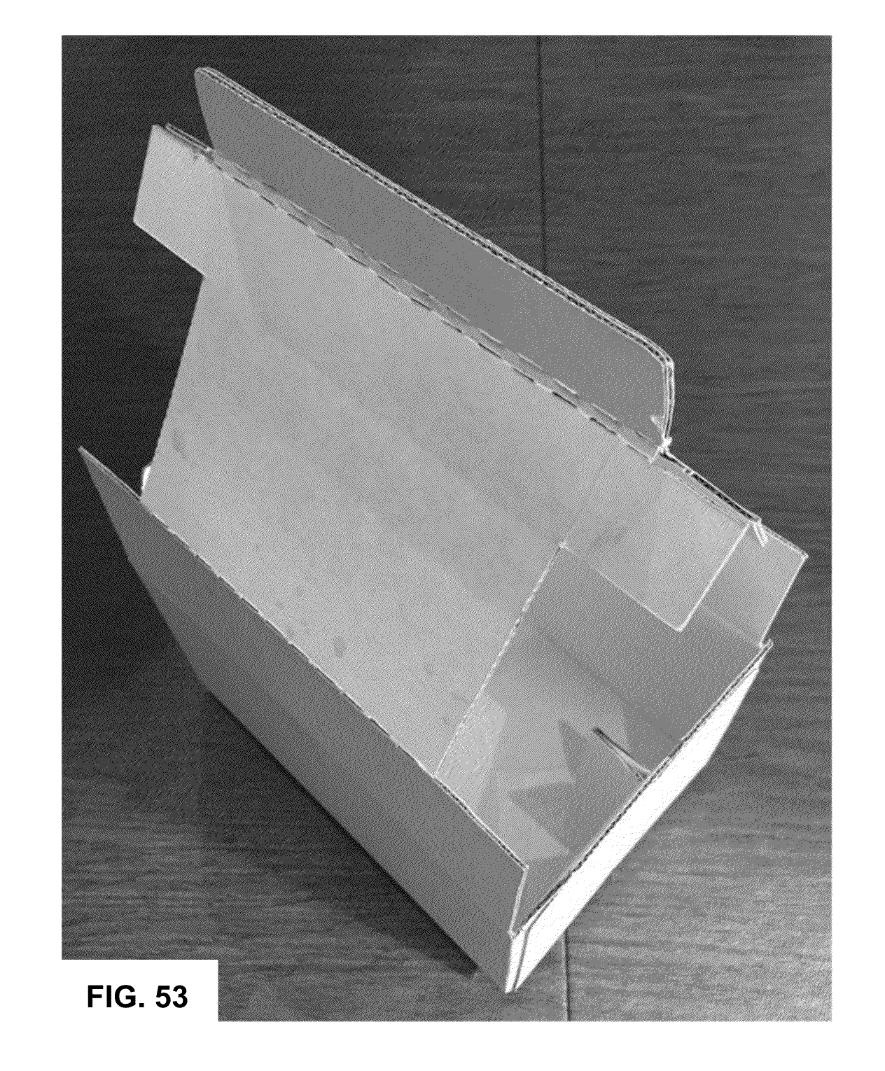

FIG. 53 is another view similar to that of FIG. 52.

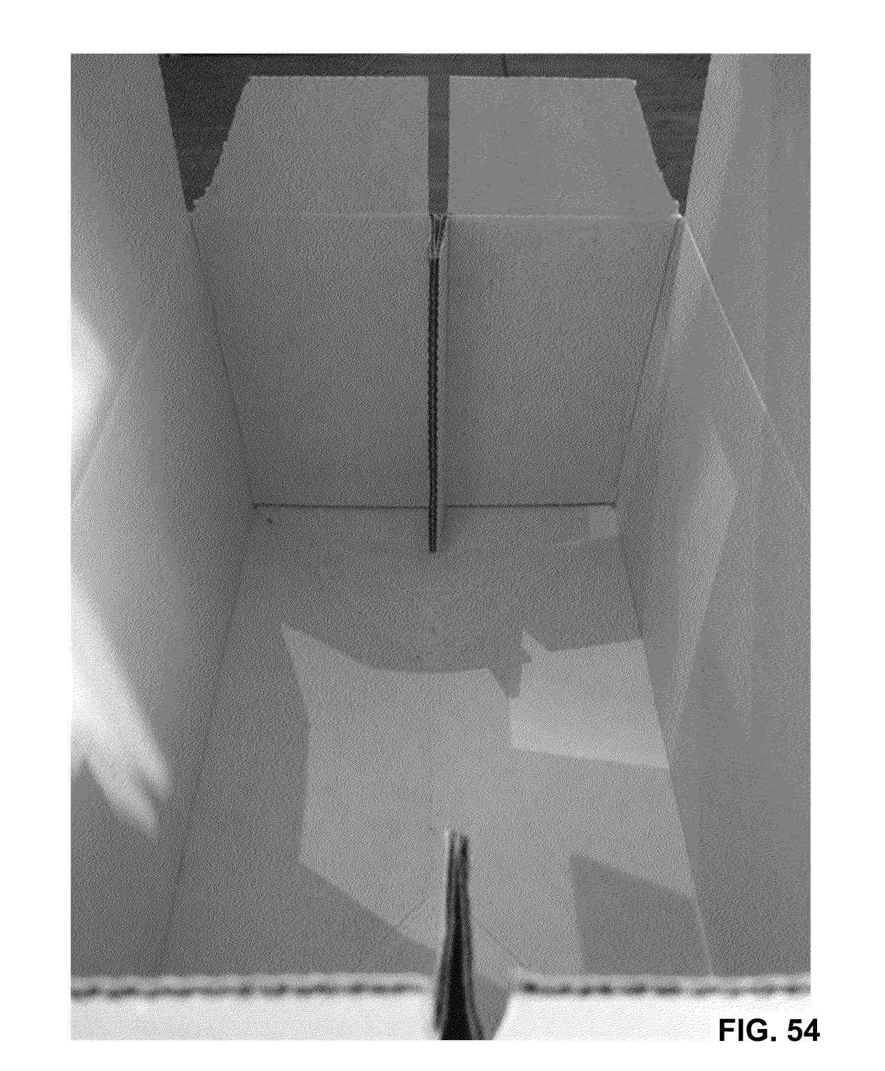

FIG. 54 shows an interior side of the body of the box of FIGS. 48-51 after expanding the body of the box, with a top portion of the box in an extended position.

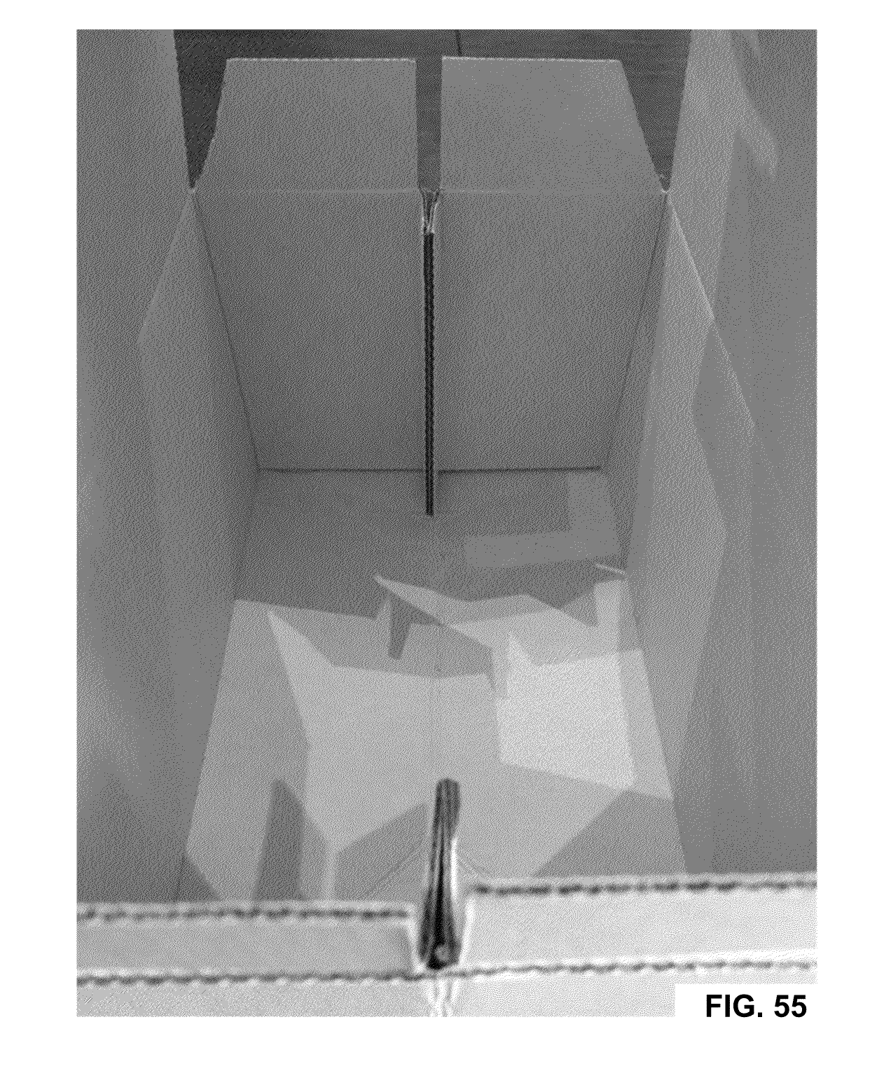

FIG. 55 is view similar to that of FIG. 54, but showing an opposite interior side.

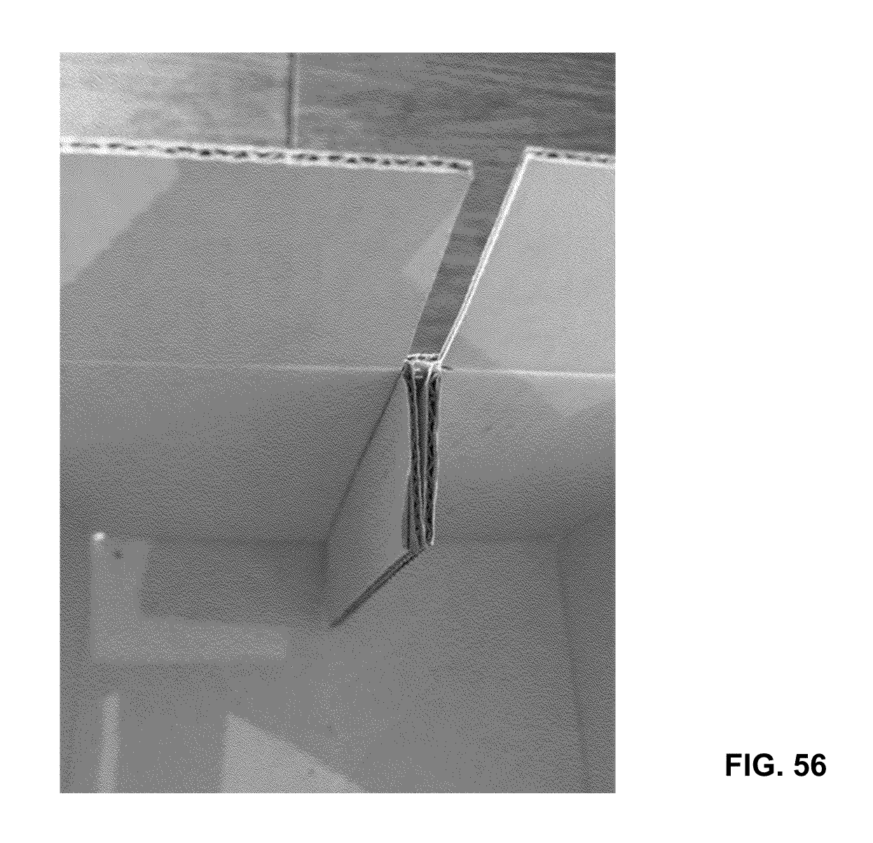

FIG. 56 is another view similar to that of FIG. 54, wherein an interior guide wall on an end wall of the body of the box is shown in focus.

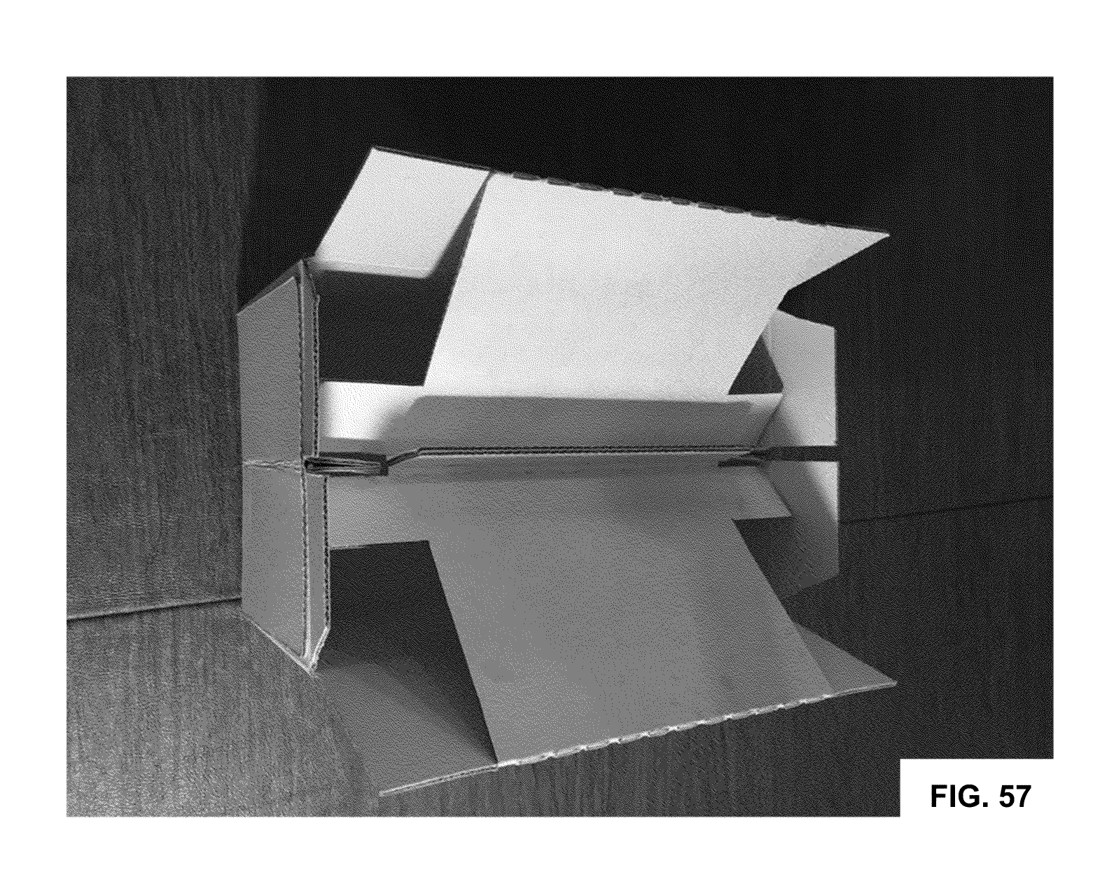

FIG. 57 shows the box of FIG. 54 with the top portion of the box in a position in which the top portion has been folded into the interior of the body of the box.

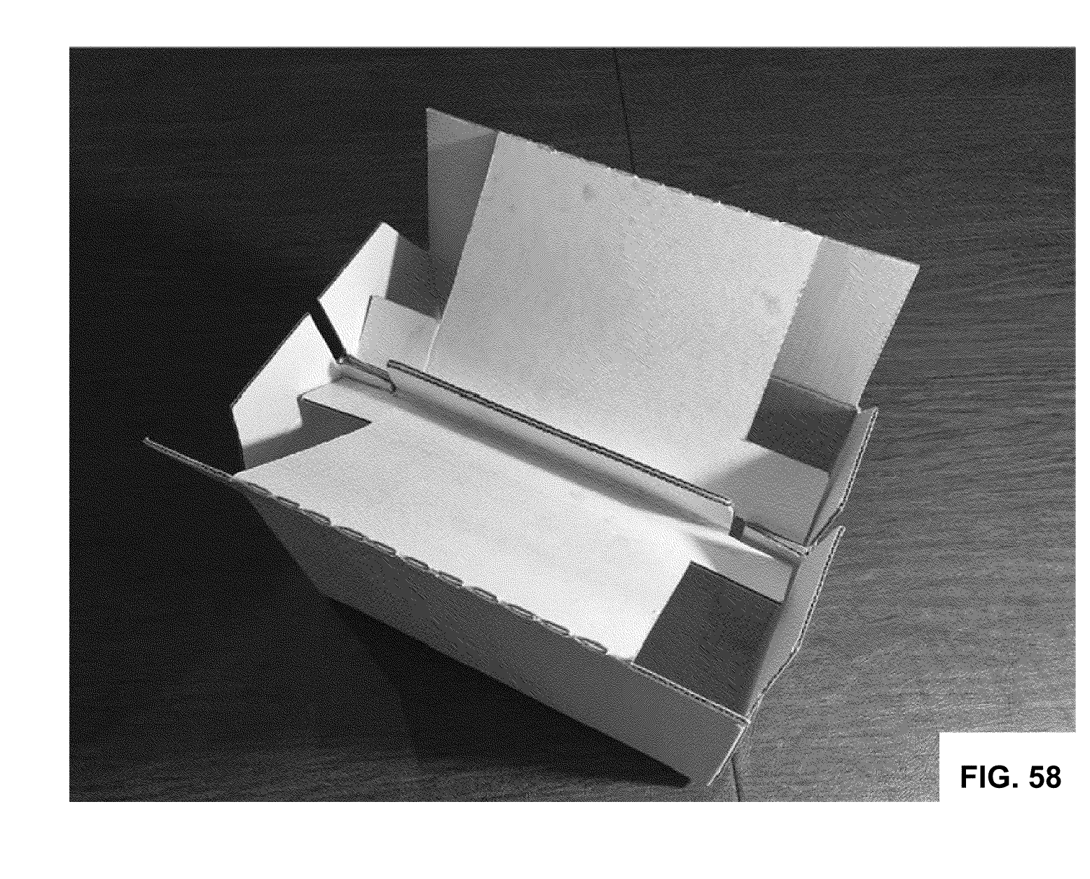

FIG. 58 is another view similar to that of FIG. 57; as shown the top portion of the box is folded below the top of each of the lids of the box in FIGS. 57 and 58.

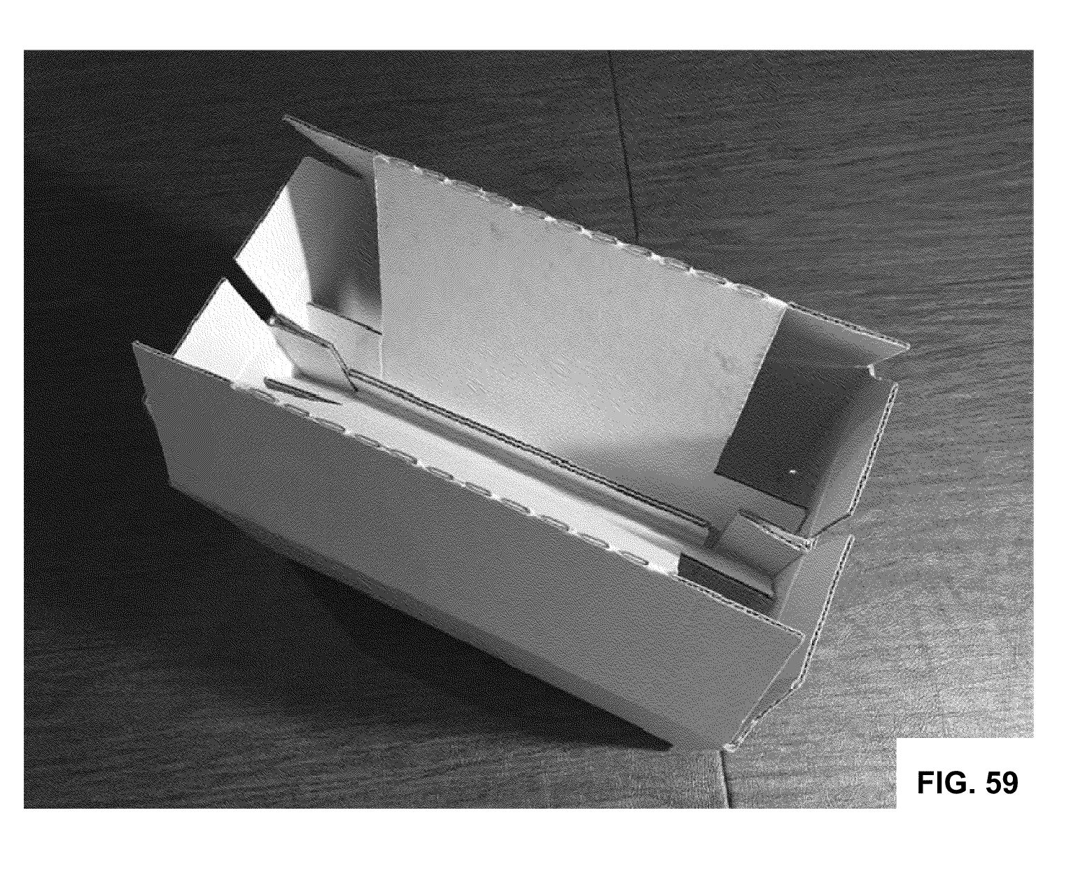

FIG. 59 shows the box of FIGS. 57 and 58 with the lids being moved toward a closed configuration of the box when considered relative to FIGS. 57 and 58.

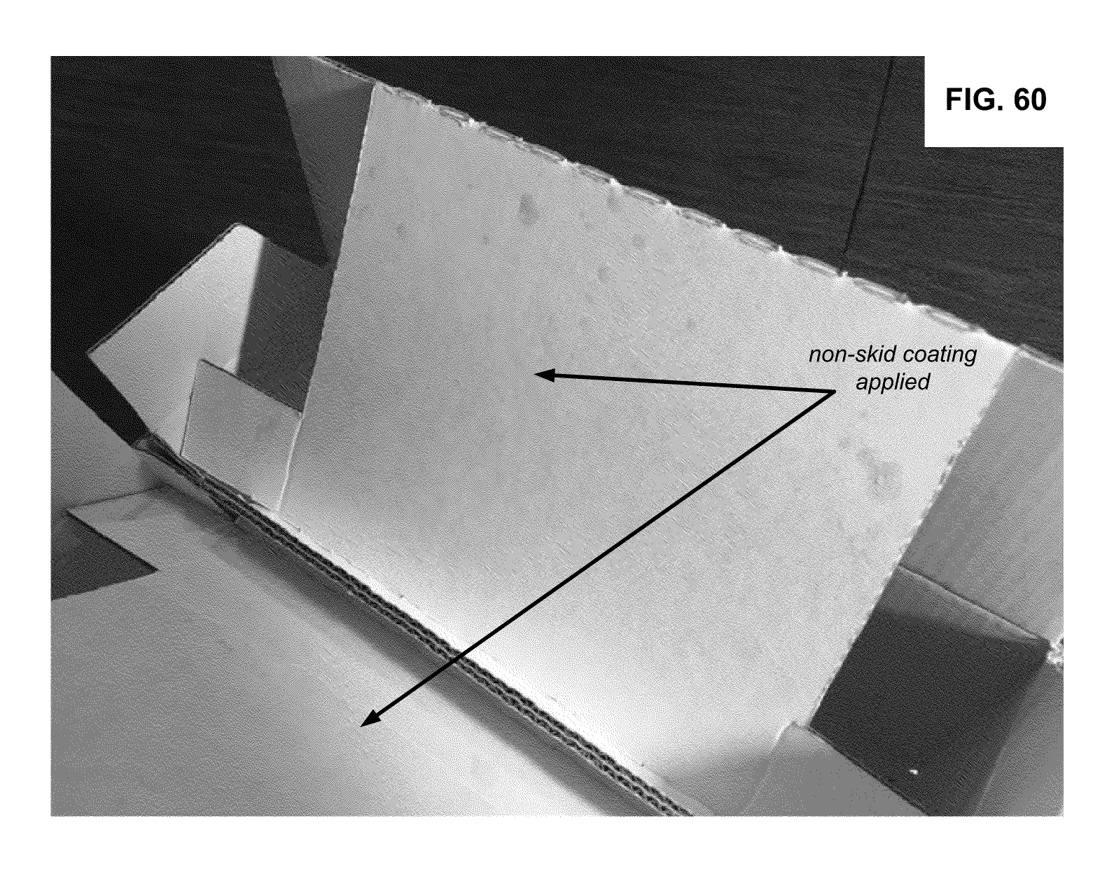

FIG. 60 shows opposed panels of the top portion to which a non-skid coating is applied; the opposed panels receive and retain one or more items packed in the box in a secure position, and the coating further assists in this respect by minimizing slipping of an item when held in frictional engagement between these opposed panels.

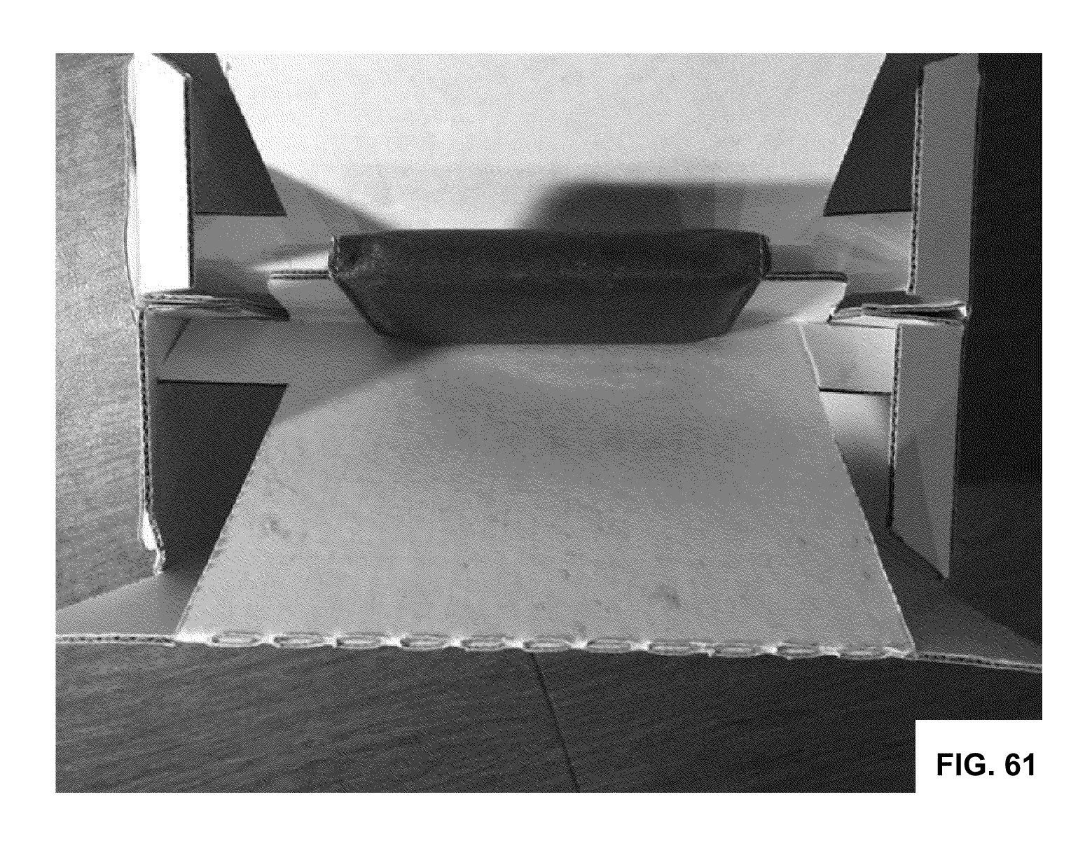

FIG. 61 shows the box of FIG. 60 having received a generally rectangular item between the opposed panels; the item is representative of, for example, a cell phone or smart phone, such as an iPhone or Galaxy phone.

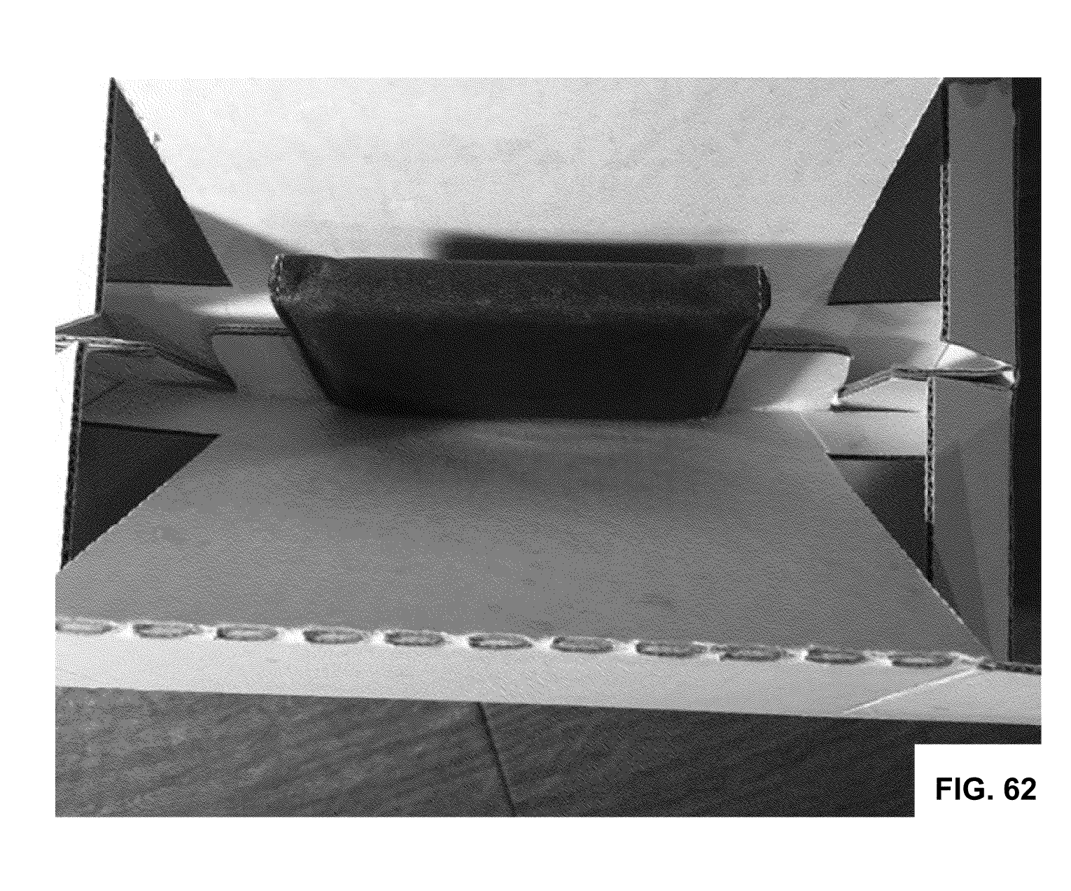

FIG. 62 is a view similar to that of FIG. 61.

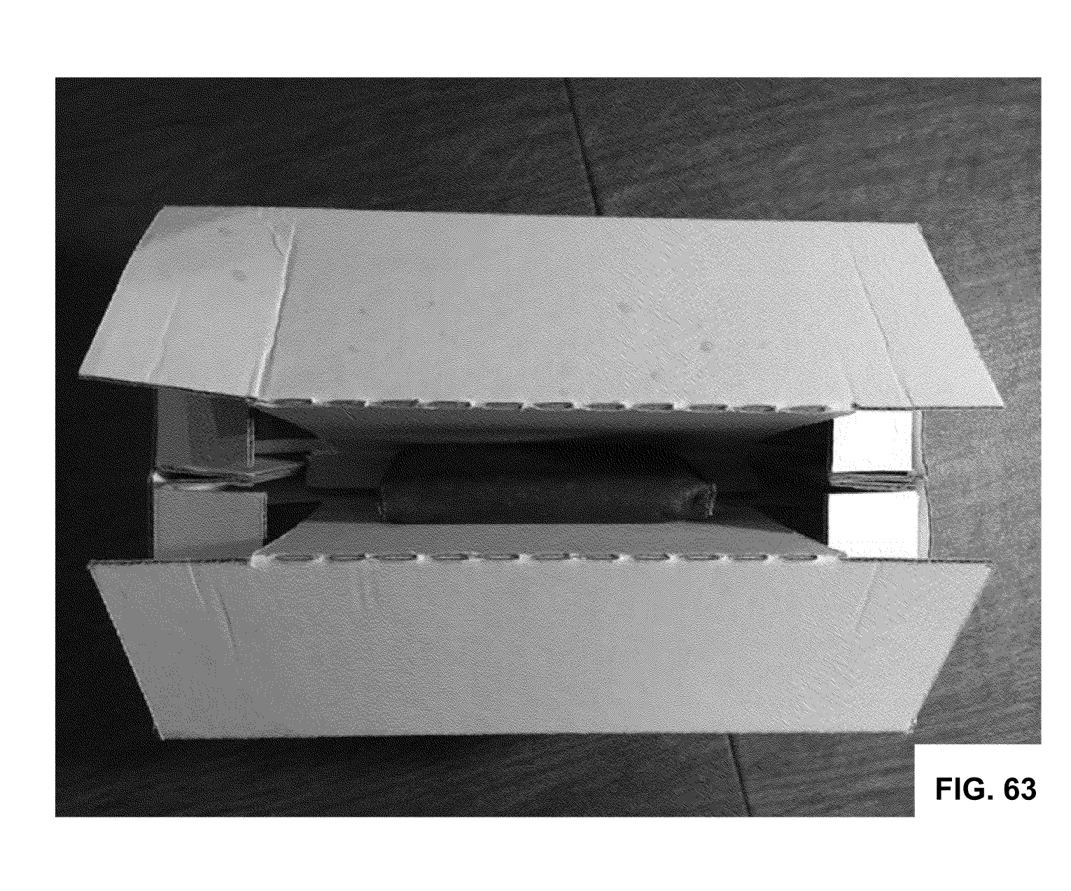

FIG. 63 shows the box of FIG. 61 with the lids moved to a closed box configuration.

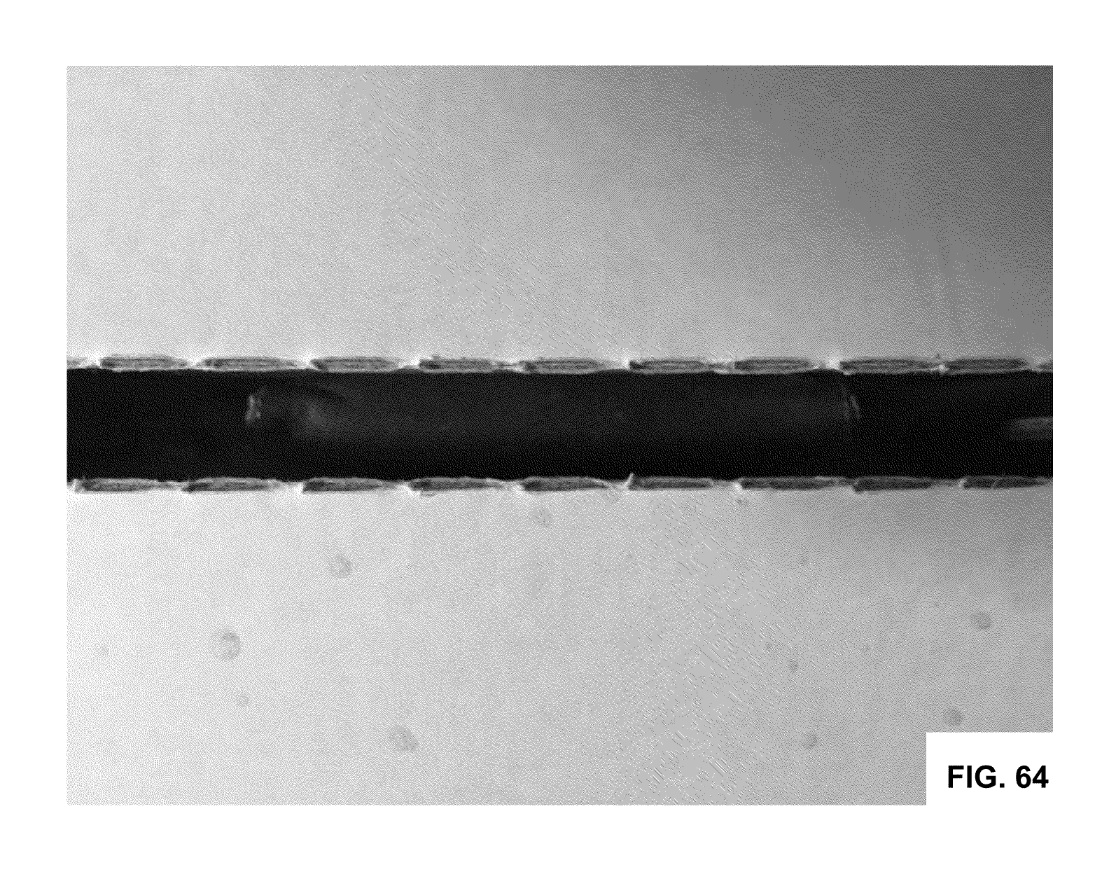

FIG. 64 shows the box of FIG. 61 with the lids further moved to a closed box configuration.

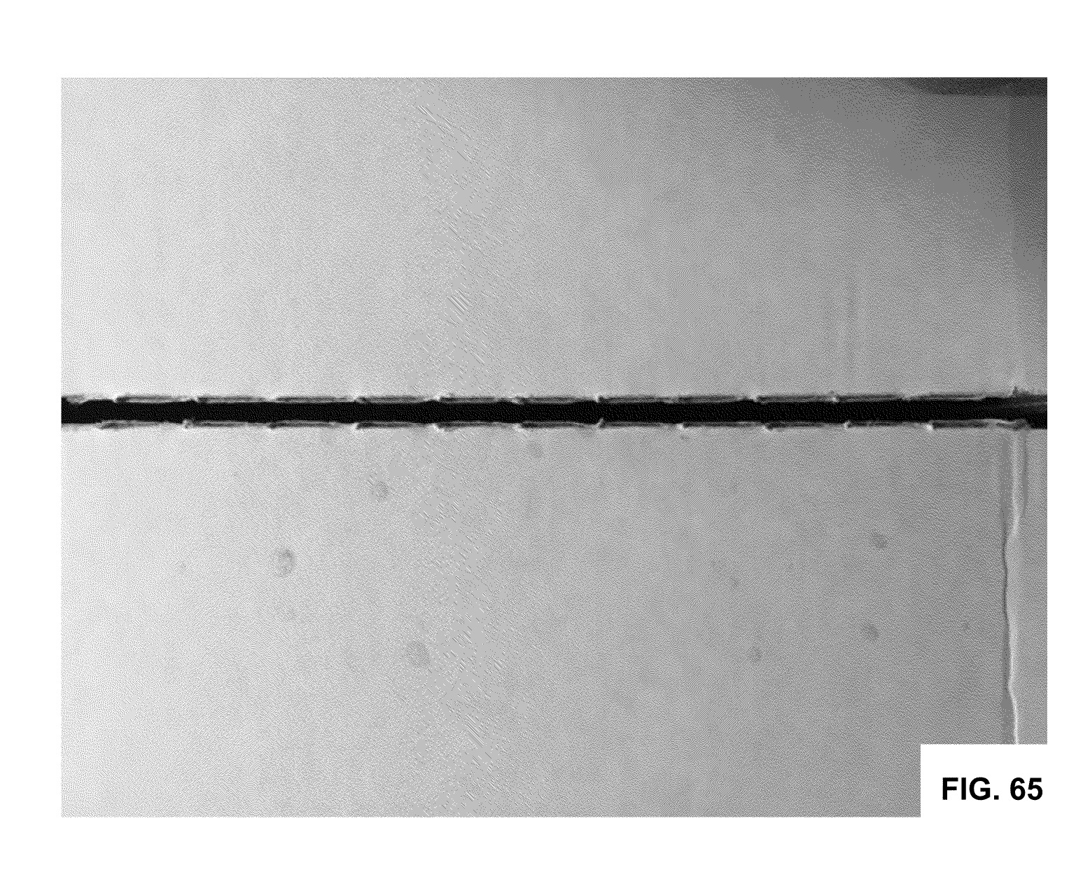

FIG. 65 shows the box of FIG. 61 with the lids in a closed configuration of the box.

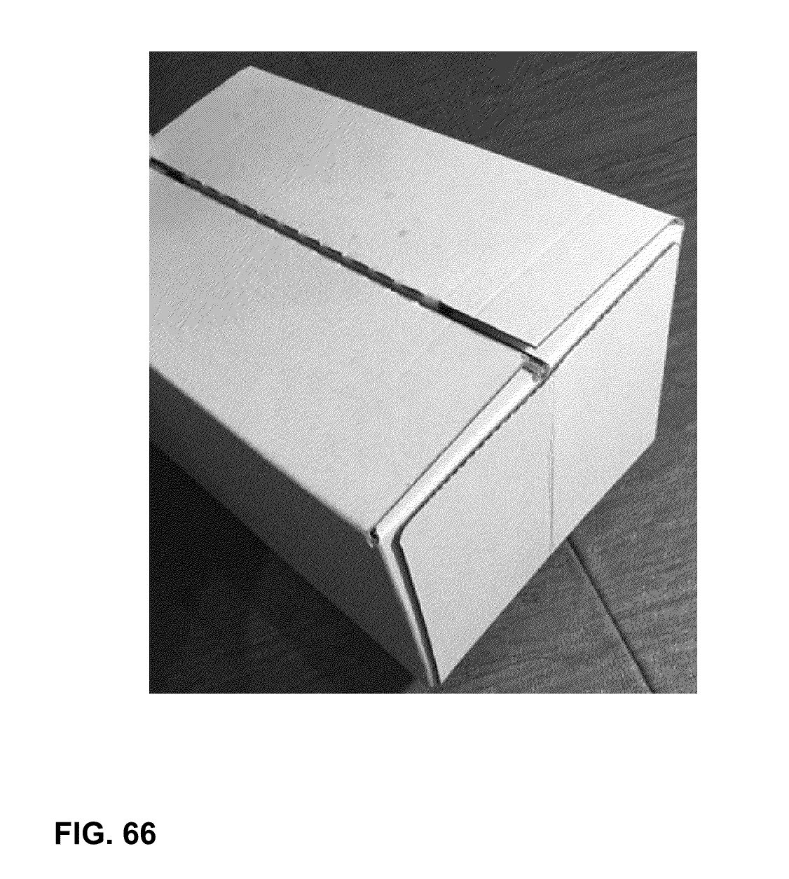

FIG. 66 is a view similar to that of FIG. 65.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and equivalents.

What is claimed is:

1. A box as shown and described.

2. An assembled box as shown and described.

3. An assembled, collapsible box as shown and described.

4. A box in the form of a blank as shown and described.

5. A method of making any of the foregoing boxes.

6. A method of assembling any of the foregoing boxes.

7. A method of collapsing and storing any of the foregoing boxes.
